(19) United States
(12) Patent Application Publication
(10) Pub. No.: US 2023/0133905 A1
(43) Pub. Date: May 4, 2023

(54) CURABLE COMPOSITION, CURED FILM, METHOD OF PRODUCING CURED FILM, ELEMENT, AND DISPLAY DEVICE

(71) Applicant: AGC Inc., Tokyo (JP)

(72) Inventors: Takefumi ABE, Tokyo (JP); Saki TAKEI, Tokyo (JP); Kaori TSURUOKA, Tokyo (JP); Keigo MATSUURA, Tokyo (JP); Yoshitaka NOMURA, Tokyo (JP); Nobuyuki OTOZAWA, Tokyo (JP); Tomoaki SAKURADA, Tokyo (JP)

(73) Assignee: AGC Inc., Tokyo (JP)

(21) Appl. No.: 18/088,989

(22) Filed: Dec. 27, 2022

Related U.S. Application Data
(63) Continuation of application No. PCT/JP2021/023238, filed on Jun. 18, 2021.

(30) Foreign Application Priority Data
Jun. 30, 2020 (JP) 2020-113383

(51) Int. Cl. C08G 65/00; G02B 1/04; C08J 5/18

(52) U.S. Cl. CPC C08G 65/007; G02B 1/04; C08J 5/18; C08J 2371/00

(57) ABSTRACT

Provided are a curable composition and an application thereof. The curable composition contains: a compound A having a polymerizable group (a) and an oxyfluoroalkylene group; a polymerization initiator; and a compound B having a polymerizable group different from the polymerizable group (a). The polymerizable group (a) in the compound A is at least one selected from the group consisting of a vinylphenyl group, a vinylphenyloxy group, a vinylbenzyloxy group, a vinyloxy group, a vinyloxycarbonyl group, a vinylamino group, a vinylaminocarbonyl group, a vinylthio group, an allyloxy group, an allyloxycarbonyl group, an allylamino group, an allylaminocarbonyl group, an allylthio group, an epoxy group, and an epoxycycloalkyl group.

### CROSS-REFERENCE TO RELATED APPLICATION

This application is a Continuation of International Application No. PCT/JP2021/023238, filed Jun. 18, 2021, which claims priority to Japanese Patent Application No. 2020-113383 filed Jun. 30, 2020. Each of the above applications is hereby expressly incorporated by reference, in its entirety, into the present application.

### TECHNICAL FIELD

The present disclosure relates to a curable composition, a cured film, a method of producing a cured film, an element, and a display device.

### BACKGROUND ART

An organic light emitting element display device is a display device that emits light by itself using an electroluminescence phenomenon, and includes an organic light emitting element. The organic light emitting element needs a sealing film in order to prevent damage due to moisture and/or oxygen entering from the outside. The sealing film is desirably a cured film from the viewpoint of strength. As a method of forming a cured film, in recent years, a method of applying a curable composition using an inkjet printing method and curing the composition is used because the cured film can be precisely formed at a desired position.

For example, Japanese National-Phase Publication (JP-A) No. 2019-537217 describes a composition for sealing an organic light emitting element, which has a refractive index of about 1.55 or more and a viscosity of about 10 cps to about 30 cps at 25° C., and contains a specific photocurable monomer, a non-sulfur-based photocurable monomer, and an initiator. Japanese National-Phase Publication (JP-A) No. 2019-537217 describes a (meth)acrylate compound as a photocurable monomer.

Japanese Patent Application Laid-Open (JP-A) No. 2015-110730 describes a curable composition for sealing a photosemiconductor containing a specific linear polyfluoro compound, a specific organohydrogen polysiloxane, a platinum group metal-based catalyst, a specific cyclic organopolysiloxane, and a carboxylic anhydride. Japanese Patent Application Laid-Open (JP-A) No. 2015-110730 describes that a curable composition for sealing a photosemiconductor has a viscosity of 50.0 to 50,000 mPa·s.

### SUMMARY OF INVENTION

### Technical Problem

In recent years, a curable composition is required to have a low viscosity, and a cured film formed by curing the curable composition is required to have a low dielectric constant. In the composition for sealing an organic light emitting element described in JP-A No. 2019-537217, the (meth)acrylate compound is used as the photocurable monomer, whereby the resulting cured film is considered to have a high dielectric constant. The curable composition for sealing a photosemiconductor described in JP-A No. 2015-110730 has a very high viscosity of 50.0 to 50,000 mPa·s. Conventionally, it has been difficult to achieve both a low viscosity of a curable composition and a low dielectric constant of a cured film.

The disclosure has been made in view of such circumstances, and an object of an embodiment of the present invention is to provide a curable composition capable of forming a cured film having a low viscosity and a low dielectric constant. Another object of the invention is to provide a cured film having a low dielectric constant and a method of producing the cured film. Still another object of the invention is to provide an element including a cured film having a low dielectric constant and a display device.

### Solution to Problem

Specific means for solving the above problems include the following aspects.

<1> A curable composition containing: a compound A having a polymerizable group (a) and an oxyfluoroalkylene group; a polymerization initiator; and a compound B having a polymerizable group different from the polymerizable group (a), wherein the polymerizable group (a) in the compound A is at least one selected from the group consisting of a vinylphenyl group, a vinylphenyloxy group, a vinylbenzyloxy group, a vinyloxy group, a vinyloxycarbonyl group, a vinylamino group, a vinylaminocarbonyl group, a vinylthio group, an allyloxy group, an allyloxycarbonyl group, an allylamino group, an allylaminocarbonyl group, an allylthio group, an epoxy group, and an epoxycycloalkyl group.

<2> The curable composition according to <1>, wherein a content of the compound A is 40% by mass to 90% by mass with respect to a total amount of the curable composition.

<3> The curable composition according to <1> or <2>, wherein a molecular weight of the compound A is 500 to 5000.

<4> The curable composition according to any one of <1> to <3>, wherein the compound B is at least one selected from the group consisting of a compound B1 having a polymerizable group different from the polymerizable group (a) and having an oxyfluoroalkylene group, a compound B2 having two or more polymerizable groups and having no oxyfluoroalkylene group, and a compound B3 having one polymerizable group and having no oxyfluoroalkylene group.

<5> The curable composition according to any one of <1> to <4>, wherein the polymerizable group in the compound B is at least one selected from the group consisting of a (meth)acryloyl group and a maleimide group.

<6> The curable composition according to any one of <1> to <5>, wherein the compound A is a compound represented by the following Formula (1):

M¹ᵣ₁-Y¹-Rf¹-(OX)ₘ—O-Rf²-Y²-M²ᵣ₂ Formula (1)

wherein:

in the Formula (1), each of M1 and M2 independently represents the polymerizable group (a);

each of r1 and r2 independently represents an integer of 1 or more;

Y¹ represents a (r1+1)-valent linking group having no fluorine atom;

Y² represents a (r2+1)-valent linking group having no fluorine atom;

Rf¹ represents a fluoroalkylene group in which a fluorine atom is bonded to a carbon atom bonded to Y¹;

Rf² represents a fluoroalkylene group in which a fluorine atom is bonded to a carbon atom bonded to Y²;

each of X's independently represents a fluoroalkylene group; and

m represents an integer of 1 or more.

<7> The curable composition according to <6>, wherein: in the Formula (1), (OX)ₘ includes a structure in which continuous (OX) is represented by the following Formula (2);

m represents an integer of 2 or more;

—(OX¹-OX²)ₐ— Formula (2)

wherein:

in the Formula (2), X¹ represents a fluoroalkylene group having 1 to 6 carbon atoms; X² represents a fluoroalkylene group having 1 to 6 carbon atoms which is different from X¹; and

a represents an integer of 1 or more, and satisfies 2≤(2×a)≤m.

<8> The curable composition according to <6> or <7>, wherein in the Formula (1), (OX)ₘ includes (OC₄F₆)_{b}, and b is an integer of 1 or more.

<9> The curable composition according to any one of <6> to <8>, wherein: in the Formula (1), (OX)ₘ includes (OC₂F₄)_{c} and (OCF₂)_{d}; each of c and d independently represents an integer of 1 or more; and d/c is 0.8 or more.

<10> The curable composition according to any one of <6> to <9>, wherein in the Formula (1), (OX)ₘ includes (OC₃F₆)e, and e is an integer of 1 or more.

<11> The curable composition according to any one of <6> to <10>, wherein in the Formula (1), each of Y¹ and Y² independently represents a single bond or represent a linking group containing at least one selected from the group consisting of an alkylene group, an arylene group, —C(═O)—, —O—, —S—, —NH—, —N<, —SiH₂—, >SiH—, and >Si<.

<12> The curable composition according to any one of <1> to <11>, wherein a content of an organic solvent is 1% by mass or less with respect to a total amount of the curable composition.

<13> The curable composition according to any one of <1> to <12>, further containing a silane coupling agent.

<14> A cured film which is a cured product of the curable composition according to any one of <1>to <13>.

<15> A method of producing a cured film, the method including the steps of: applying the curable composition according to any one of <1> to <14>onto a substrate; and irradiating the curable composition with an active energy ray.

<16> An element including the cured film according to <14>.

<17> The element according to <16>, wherein the element is used for a sensor.

<18> The element according to <16>, wherein the element is used for optics.

<19> A display device including an optical element which is the element according to <18>.

### Advantageous Effects of Invention

The disclosure provides a curable composition capable of forming a cured film having a low viscosity and a low dielectric constant.

The disclosure provides a cured film having a low dielectric constant and a method of producing the cured film.

The disclosure provides an element including a cured film having a low dielectric constant, and a display device.

### DESCRIPTION OF EMBODIMENTS

Hereinafter, a curable composition, a cured film, a method of producing the cured film, an element, and a display device of the disclosure will be described in detail.

In the present specification, a numerical range indicated using “to” means a range including numerical values described before and after “to” as a minimum value and a maximum value, respectively.

In the specification, in a case in which there are a plurality of substances corresponding to each component in the composition, the amount of each component in the composition means the total amount of the plurality of substances present in the composition unless otherwise particularly specified.

In the specification, a combination of two or more preferred aspects is a more preferred aspect.

In the specification, the term “step” includes not only an independent step but also a step that cannot be clearly distinguished from other steps, as long as the intended object of the step is achieved.

In the specification, the term “(meth)acrylate” means at least one of acrylate or methacrylate. The term “(meth)acryloyl group” means at least one of an acryloyl group or a methacryloyl group, and the term “(meth)acrylic” means at least one of acrylic or methacrylic.

### Curable Composition

The curable composition of the disclosure contains a compound A having a polymerizable group (a) and an oxyfluoroalkylene group, a polymerization initiator, and a compound B having a polymerizable group different from the polymerizable group (a). The polymerizable group (a) in the compound A is at least one selected from the group consisting of a vinylphenyl group, a vinylphenyloxy group, a vinylbenzyloxy group, a vinyloxy group, a vinyloxycarbonyl group, a vinylamino group, a vinylaminocarbonyl group, a vinylthio group, an allyloxy group, an allyloxycarbonyl group, an allylamino group, an allylaminocarbonyl group, an allylthio group, an epoxy group, and an epoxycycloalkyl group.

The curable composition of the disclosure contains a compound A having a polymerizable group (a) and an oxyfluoroalkylene group. In particular, the polymerizable group (a) in the compound A is at least one selected from the group consisting of a vinylphenyl group, a vinylphenyloxy group, a vinylbenzyloxy group, a vinyloxy group, a vinyloxycarbonyl group, a vinylamino group, a vinylaminocarbonyl group, a vinylthio group, an allyloxy group, an allyloxycarbonyl group, an allylamino group, an allylaminocarbonyl group, an allylthio group, an epoxy group, and an epoxycycloalkyl group, and thus a cured film having a low viscosity and a low dielectric constant can be formed.

Hereinafter, each of the components contained in the curable composition of the disclosure will be described.

### Compound A

The curable composition of the disclosure contains the compound A having a polymerizable group (a) and an oxyfluoroalkylene group.

The polymerizable group (a) is at least one selected from the group consisting of a vinylphenyl group, a vinylphenyloxy group, a vinylbenzyloxy group, a vinyloxy group, a vinyloxycarbonyl group, a vinylamino group, a vinylaminocarbonyl group, a vinylthio group, an allyloxy group, an allyloxycarbonyl group, an allylamino group, an allylaminocarbonyl group, an allylthio group, an epoxy group, and an epoxycycloalkyl group. Among them, from the viewpoint of further decreasing the dielectric constant of the cured film, the polymerizable group (a) is preferably at least one selected from the group consisting of a vinylphenyl group, a vinylphenyloxy group, a vinylbenzyloxy group, a vinyloxy group, an allyloxy group, an allylamino group, an epoxy group, and an epoxycycloalkyl group, and from the viewpoint of the curability of the curable composition, the polymerizable group (a) is more preferably a vinylbenzyloxy group, an epoxy group, or an epoxycycloalkyl group.

The number of carbon atoms of a cycloalkyl ring in the epoxycycloalkyl group is, for example, 4 to 8. Among them, the epoxycycloalkyl group is preferably an epoxycyclopentyl group or an epoxycyclohexyl group from the viewpoint of a low dielectric constant and ease of synthesis.

Specific examples of the epoxycyclopentyl group include the following groups. * represents a binding site.

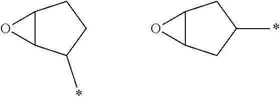

Specific examples of the epoxycyclohexyl group include the following groups. * represents a binding site.

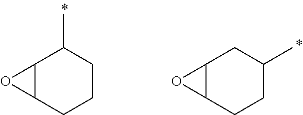

The compound A is preferably a compound represented by the following Formula (1).

M¹ᵣ₁-Y¹-Rf¹-(OX)ₘ—O-Rf²-Y²-M²ᵣ₂ Formula (1)

In the Formula (1),

each of M¹ and M² independently represents the polymerizable group (a);

each of r1 and r2 independently represents an integer of 1 or more;

Y¹ represents a (r1+1)-valent linking group having no fluorine atom;

Y² represents a (r2+1)-valent linking group having no fluorine atom;

Rf¹ represents a fluoroalkylene group in which a fluorine atom is bonded to a carbon atom bonded to Y¹;

Rf² represents a fluoroalkylene group in which a fluorine atom is bonded to a carbon atom bonded to Y²;

each of X's independently represents a fluoroalkylene group; and

m represents an integer of 1 or more.

### M¹, M²

In the Formula (1), each of M¹ and M² independently represents the polymerizable group (a). All of r1 M¹'s and r2 M²'s in the Formula (1) may represent the same polymerizable group (a), or may represent polymerizable groups a different from each other. From the viewpoint of ease of synthesis and curability, it is preferable that the r1 polymerizable groups a represented by M¹ and the r2 polymerizable groups a represented by M² in the Formula (1) are all the same.

### r1, r2

In the Formula (1), each of r1 and r2 independently represents an integer of 1 or more. The integer represented by r1 and the integer represented by r2 in the Formula (1) may be the same or different from each other. From the viewpoint of ease of synthesis, the integer represented by r1 and the integer represented by r2 in the Formula (1) are preferably the same. The average value of r1 and r2 is preferably 1 to 6, more preferably 1 to 4, still more preferably 1 to 2, and particularly preferably 1 from the viewpoint of decreasing the viscosity of the curable composition.

### Y¹, Y²

In the Formula (1), Y¹ represents a (r1+1)-valent linking group having no fluorine atom, and Y² represents a (r2+1)-valent linking group having no fluorine atom. The linking group represented by Y¹ and the linking group represented by Y² in the Formula (1) may be the same or different from each other. From the viewpoint of ease of synthesis, the linking group represented by Y¹ and the linking group represented by Y² in the Formula (1) are preferably the same. Here, the fact that the linking group represented by Y¹ and the linking group represented by Y² are the same means that the structure of Y¹ from a binding site with Rf¹ to a binding site with M¹ is the same as the structure of Y² from a binding site with Rf² to a binding site with M².

Examples of the linking group represented by Y¹ or Y² in the Formula (1) (hereinafter also referred to as “linking group Y”) include a single bond and a linking group containing at least one selected from the group consisting of an alkylene group, an arylene group, —O—, —N<, —SiH₂—, >SiH—, and >Si<. Hereinafter, an alkylene group, an arylene group, —O—, —N<, —SiH₂—, >SiH—, and >Si< are also referred to as “unit linking group”.

The alkylene group as the unit linking group may be a linear alkylene group, a branched alkylene group, or a cyclic alkylene group (that is, a cycloalkylene group). The number of carbon atoms of the alkylene group as the unit linking group is, for example, 1 to 10, preferably 1 to 6, and more preferably 1 to 4.

Examples of the arylene group as the unit linking group include a phenylene group and a naphthylene group. Examples of the phenylene group include an o-phenylene group, a m-phenylene group, and a p-phenylene group. Among them, the arylene group as the unit linking group is preferably a phenylene group.

The linking group Y may contain only one unit linking group, or may contain a combination of two or more unit linking groups. Examples of the combination of two or more thereof include —CO—NH—, —NH—CO—, —C(═O)—O—, —S—S—, —O—C(═O)—NH—, —NH—C(═O)—O—, —NH—C(═O)—NH—, -Ry-O—, —O-Ry-, -Ry-O-Ry-, -Ry-Ary-, —O-Ry-Ary-, -Ry-O-Ry-Ary-, —O—SiH₂—, —SiH₂—O—, —O—SiH<, >SiH—O—, —O—Si(CH₃)₂—, —Si(CH₃)₂—O—, the following Formula (Y-A), the following Formula (Y-B), the following Formula (Y-C), the following Formula (Y-D), the following Formula (Y-E), and the following Formula (Y-F). Here, Ry represents an alkylene group as the unit linking group. Rz represents an alkyl group as a substituent to be described later. Ary represents an arylene group as the unit linking group.

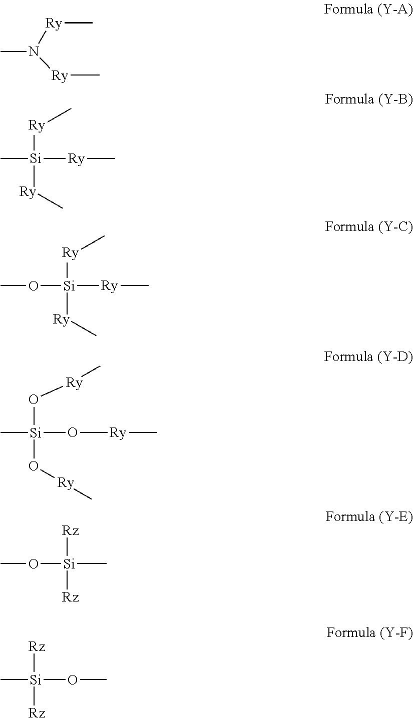

The linking group Y may further have a substituent. Examples of the substituent that the linking group Y may further have include an alkyl group, an alkoxy group, a hydroxy group, an amino group, a thiol group, and a hydrosilyl group. The alkyl group and the alkoxy group as the substituent may be linear or branched. The number of carbon atoms of the alkyl group and the alkoxy group as the substituent is, for example, 1 to 6, preferably 1 to 4, and more preferably 1.

In the linking group Y, the unit linking group directly bonded to the polymerizable group (a) represented by M¹ or M² is preferably an alkylene group.

Examples of the linking group Y include linking groups represented by the following Formulas (Y-1) to (Y-21).

Here, in the following Formula, “Rf*” represents a binding site to the fluoroalkylene group represented by Rf¹ or Rf² in the Formula (1), and “*M” represents a binding site to the polymerizable group (a) represented by M¹ or M² in the Formula (1).

In the following Formula, B¹ is a group directly bonded to the fluoroalkylene group represented by Rf¹ or Rf² in the Formula (1), and represents a single bond, Rf*—CₙH₂ₙ—O—, Rf*—O—, Rf*—C(═O)—NH—, Rf*—NH—C(═O)—, Rf*—C(═O)—O—, Rf*—O—C(═O)—, Rf*—S—, Rf*—S—S—, Rf*—O—C(═O)—NH—, Rf*—NH—C(═O)—O—, or Rf*—NH—C(═O)—NH—. Here, n represents an integer of 1 to 6.

In the following Formula, B² is a group directly bonded to the polymerizable group (a) represented by M¹ or M² in the Formula (1), and each independently represents a single bond, —O—CₙH₂ₙ—*M, —Ph—*M, or —O—CH₂—Ph—*M. Here, n represents an integer of 1 to 6, and Ph represents a phenylene group.

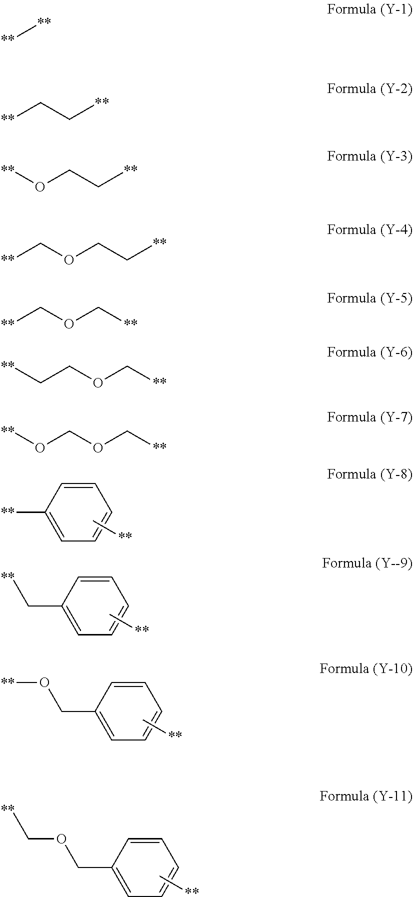

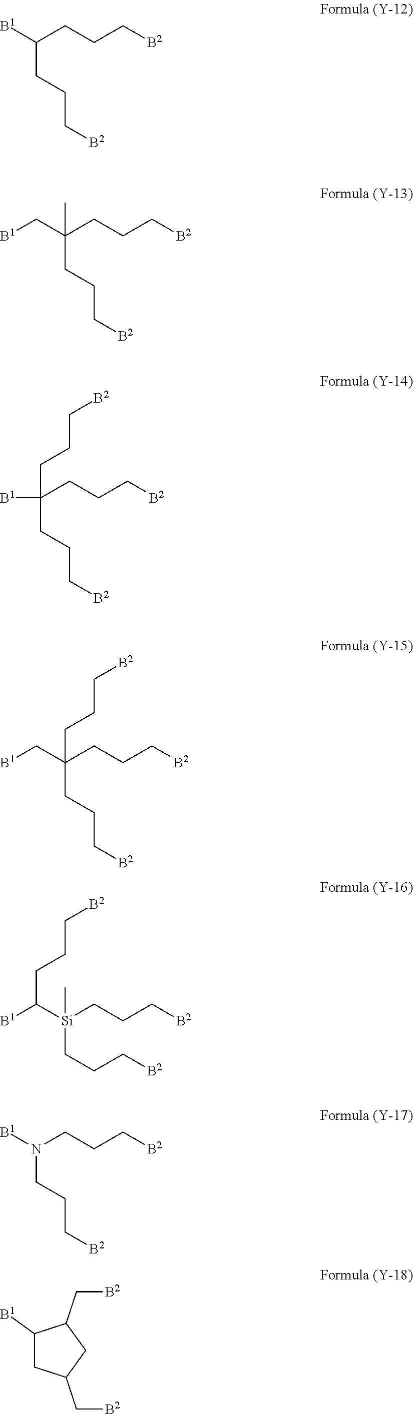

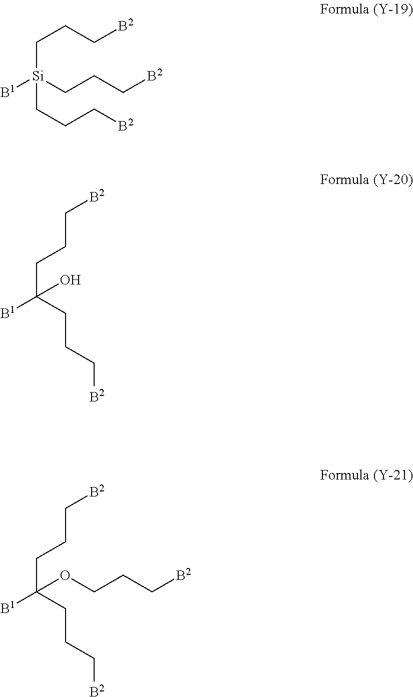

### Rf¹, Rf²

Each of Rf¹ and Rf² in the Formula (1) independently represents a fluoroalkylene group in which a fluorine atom is bonded to a carbon atom bonded to the linking group Y. The fluoroalkylene group represented by Rf¹ and the fluoroalkylene group represented by Rf² in the Formula (1) may be the same or different from each other. From the viewpoint of ease of synthesis, the fluoroalkylene group represented by Rf¹ and the fluoroalkylene group represented by Rf² in the Formula (1) are preferably the same. Here, the fact that the fluoroalkylene group represented by Rf¹ and the fluoroalkylene group represented by Rf² are the same means that the structure of Rf¹ from a bonding site with an O atom to a bonding site with Y¹ is the same as the structure of Rf² from a bonding site with an O atom to a bonding site with Y².

The number of carbon atoms of the fluoroalkylene group represented by Rf¹ or Rf² in the Formula (1) (hereinafter also referred to as “fluoroalkylene group Rf”) is preferably 1 to 6, more preferably 1 to 5, and still more preferably 1 to 4.

The fluoroalkylene group Rf may be a linear fluoroalkylene group, a branched fluoroalkylene group, or a fluoroalkylene group having a cyclic structure. Examples of the cyclic structure include a cyclobutane structure and a cyclohexane structure.

The fluoroalkylene group Rf is preferably a linear fluoroalkylene group or a branched fluoroalkylene group from the viewpoint of decreasing the viscosity of the curable composition, and is more preferably a linear perfluoroalkylene group or a branched perfluoroalkylene group from the viewpoint of decreasing the dielectric constant of the cured film.

Specific examples of the fluoroalkylene group Rf include
^{o}*—CHF—*^{Y},
^{o}*—CF₂CHF—*^{Y},
^{o}*—CHFCF₂—*^{Y},
^{o}*—CH₂CF₂—*^{Y},
^{o}*—CF₂CF₂CHF—*^{Y},
^{o}*—CHFCF₂CF₂—*^{Y},
^{o}*—CH₂CF₂CF₂—*^{Y},
^{o}*—CH₂CF₂CF₂CF₂—*^{Y},
^{o}*—CH₂CF₂CF₂CF₂CF₂—*^{Y},
^{o}*—CH₂CF₂CF₂CF₂CF₂CF₂—*^{Y},
^{o}*—CF₂—*^{Y},
^{o}*—CF₂CF₂—*^{Y},
^{o}*—CF₂CF₂CF₂—*^{Y},
^{o}*—CF(CF₃)CF₂—*^{Y},
^{o}*—CF₂CF₂CF₂CF₂—*^{Y},
^{o}*—CF(CF₃)CF₂CF₂—*^{Y},
^{o}*—CF₂CF₂CF₂CF₂CF₂—*^{Y},
^{o}*—CF₂CF₂CF₂CF₂CF₂CF₂—*^{Y},

groups represented by the following Formulas (Rf-1) to (Rf-9), and

groups represented by the following Formulas (Rf-1) to (Rf-9) in which some of fluorine atoms are replaced with hydrogen. The fluoroalkylene group Rf is not limited to these specific examples. Here, “o*” represents a binding site to an oxygen atom in the Formula (1), and “*Y” represents a binding site to a linking group represented by Y¹ or Y² in the Formula (1).

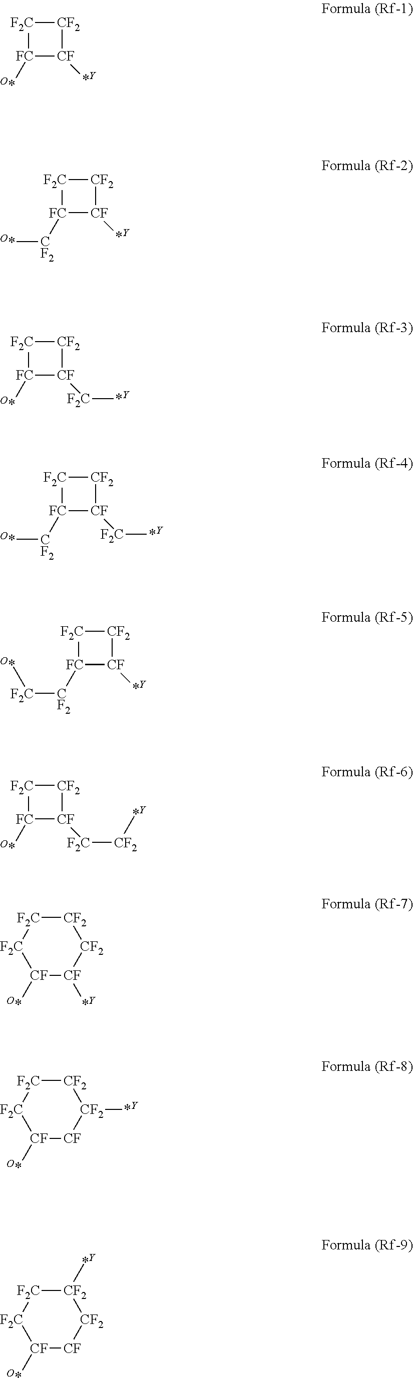

### X

In the Formula (1), each of X's independently represents a fluoroalkylene group.

The number of carbon atoms of the fluoroalkylene group represented by X in the Formula (1) (hereinafter also referred to as “fluoroalkylene group X”) is preferably 6 or less from the viewpoint of decreasing the viscosity of the curable composition before curing, and is preferably 1 or more, and more preferably 2 or more from the viewpoint of decreasing the dielectric constant of the cured film. That is, the number of carbon atoms is preferably 1 to 6, and more preferably 2 to 6.

The fluoroalkylene group X may be a linear fluoroalkylene group, a branched fluoroalkylene group, or a fluoroalkylene group having a cyclic structure. Examples of the cyclic structure include a cyclobutane structure and a cyclohexane structure. The fluoroalkylene group X is preferably a perfluoroalkylene group from the viewpoint of decreasing the dielectric constant of the resulting cured film.

Specific examples of the fluoroalkylene group X include
¹*—CHF—*²,
¹*—CF2CHF—*²,
¹*—CHFCF₂—*²,
¹*—CH₂CF₂—*²,
¹*—CF₂CH₂—*²,
¹*—CF₂CF₂CHF—*²,
¹*—CF₂CHFCF₂—*²,
¹*—CHFCF₂CF₂—*²,
¹*—CH₂CF₂CF₂—*²,
¹*—CF₂CH₂CF₂—*²,
¹*—CF₂CF₂CH₂—*²,
¹*—CHFCF₂CHF—*²,
¹*—CHFCF₂CF₂CF₂—*²,
¹*—CF₂CHFCF₂CF₂—*²,
¹*—CF₂CF₂CHFCF₂—*²,
¹*—CF₂CF₂CF₂CHF—*²,
¹*—CH₂CF₂CF₂CF₂—*²,
¹*—CF₂CF₂CF₂CH₂—*²,
¹*—CH₂CF₂CF₂CF₂CF₂—*²,
¹*—CF₂CF₂CF₂CF₂CH₂—*²,
¹*—CH₂CF₂CF₂CF₂CH₂—*²,
¹*—CH₂CF₂CF₂CF₂CF₂CF₂—*²,
¹*—CF₂CF₂CF₂CF₂CH₂—*²,
¹*—CH₂CF₂CF₂CF₂CF₂CH₂—*²,
¹*—CF₂—*²,
¹*—CF₂CF₂—*²,
¹*—CF₂CF₂CF₂₂—*²,
¹*—CF(CF₃)CF₂—*²,
¹*—CF₂CF₂CF₂CF₂—*²,
¹*—CF(CF₃)CF₂CF₂—*²,
¹*—CF₂CF₂CF₂CF₂CF₂—*²,
¹*—CF₂CF₂CF₂CF₂CF₂CF₂—*²,

groups represented by the following Formulas (X-1) to (X-9), and

a group in which some of fluorine atoms in groups represented by the following Formulas (X-1) to (X-9) are replaced with hydrogen. The fluoroalkylene group X is not limited to these specific examples. Here, “1*” represents a binding site on a side close to Rf¹ in the Formula (1), and “*2” represents a binding site on a side close to Rf² in the Formula (1).

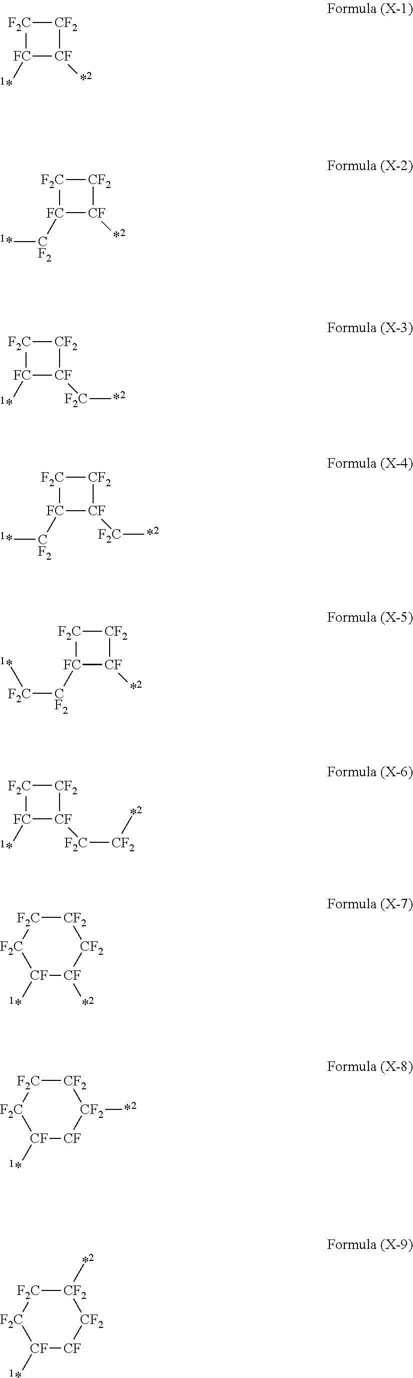

### m

In the Formula (1), m is an integer of 1 or more. From the viewpoint of decreasing the dielectric constant of the resulting cured film, m is preferably 1 or more, and more preferably 2 or more. From the viewpoint of decreasing the viscosity of the curable composition, m is preferably 400 or less, more preferably 200 or less, and still more preferably 100 or less.

In the Formula (1), it is preferable that (OX)ₘ includes a structure in which continuous (OX) is represented by Formula (2) (hereinafter also referred to as “structure (2)”), and m represents an integer of 2 or more.

—(OX¹-OX²)ₐ— Formula (2)

In the Formula (2), X¹ represents a fluoroalkylene group having 1 to 6 carbon atoms.

X² represents a fluoroalkylene group having 1 to 6 carbon atoms which is atoms different from X¹.

a represents an integer of 1 or more, and satisfies 2≤(2×a)≤m.

X¹ and X² in the Formula (2) represent fluoroalkylene groups different from each other, and each of X¹ and X² independently represents a fluoroalkylene group having 1 to 6 carbon atoms. The fluoroalkylene group represented by X¹ or X² in the Formula (2) may be a linear fluoroalkylene group, a branched fluoroalkylene group, or a fluoroalkylene group having a cyclic structure. Specific examples of the fluoroalkylene group represented by X¹ or X² in the Formula (2) include the fluoroalkylene group having 1 to 6 carbon atoms among those listed as specific examples of the fluoroalkylene group X. The fluoroalkylene group represented by X¹ or X² in the Formula (2) is not limited to these specific examples.

Examples of the fluoroalkylene groups different from each other include fluoroalkylene groups having different numbers of carbon atoms, fluoroalkylene groups having the same number of carbon atoms and different structures, and fluoroalkylene groups having the same number of carbon atoms, the same structure, and different numbers of hydrogen atoms.

The fluoroalkylene groups different from each other are preferably fluoroalkylene groups having different numbers of carbon atoms or fluoroalkylene groups having the same number of carbon atoms and different structures, more preferably fluoroalkylene groups having different numbers of carbon atoms, and still more preferably perfluoroalkylene groups having different numbers of carbon atoms.

Examples of the combination of different numbers of carbon atoms include a combination of the number of carbon atoms of 2 and the number of carbon atoms of 3, a combination of the number of carbon atoms of 2 and the number of carbon atoms of 4, a combination of the number of carbon atoms of 2 and the number of carbon atoms of 5, a combination of the number of carbon atoms of 2 and the number of carbon atoms of 6, a combination of the number of carbon atoms of 3 and the number of carbon atoms of 4, a combination of the number of carbon atoms of 3 and the number of carbon atoms of 5, a combination of the number of carbon atoms of 3 and the number of carbon atoms of 6, a combination of the number of carbon atoms of 4 and the number of carbon atoms of 5, a combination of the number of carbon atoms of 4 and the number of carbon atoms of 6, and a combination of the number of carbon atoms of 5 and the number of carbon atoms of 6. Among them, at least one of X¹ or X² preferably has 2 carbon atoms from the viewpoint of ease of synthesis.

In the combination of the fluoroalkylene groups having different numbers of carbon atoms, the numbers of hydrogen atoms may be different from each other in addition to the numbers of carbon atoms.

Examples of the combination of the fluoroalkylene groups having different structures include a combination of a linear fluoroalkylene group and a branched fluoroalkylene group, a combination of a linear fluoroalkylene group and a fluoroalkylene group having a cyclic structure, a combination of a branched fluoroalkylene group and a fluoroalkylene group having a cyclic structure, a combination of two branched fluoroalkylene groups having different structures, and a combination of fluoroalkylene groups having two different cyclic structures.

In the combination of the fluoroalkylene groups having different structures, the numbers of hydrogen atoms may be different from each other in addition to the structures.

The combination of X¹ and X² is preferably a combination of a fluoroalkylene group having 2 carbon atoms and a fluoroalkylene group having 6 carbon atoms, a combination of a fluoroalkylene group having 2 carbon atoms and a fluoroalkylene group having 4 carbon atoms, or a combination of a fluoroalkylene group having 2 carbon atoms and a fluoroalkylene group having 3 carbon atoms, more preferably a combination of a fluoroalkylene group having 2 carbon atoms and a fluoroalkylene group having 4 carbon atoms, still more preferably a combination of a linear fluoroalkylene group having 2 carbon atoms and a linear fluoroalkylene group having 4 carbon atoms, and particularly preferably a combination of a linear perfluoroalkylene group having 2 carbon atoms and a linear perfluoroalkylene group having 4 carbon atoms.

Among examples of the structure (2), specific examples in which the combination of X¹ and X² is a combination of a linear fluoroalkylene group having 2 carbon atoms and a linear fluoroalkylene group having 4 carbon atoms include:
—(OCF₂CF₂—OCF₂CF₂CF₂CF₂)ₐ—
—(OCF₂CF₂—OCHFCF₂CF₂CF₂)ₐ—
—(OCF₂CF₂—OCF₂CHFCF₂CF₂)ₐ—
—(OCF₂CF₂—OCF₂CF₂CHFCF₂)ₐ—
—(OCF₂CF₂—OCF₂CF₂CF₂CHF)ₐ—
—(OCF₂CF₂—OCH₂CF₂CF₂CF₂)ₐ—
—(OCF₂CF₂—OCF₂CH₂CF₂CF₂)ₐ—
—(OCF₂CF₂—OCF₂CF₂CH₂CF₂)ₐ—
—(OCF₂CF₂—OCF₂CF₂CF₂CH₂)ₐ—
—(OCHFCF₂—OCF₂CF₂CF₂CF₂)ₐ—
—(OCHFCF₂—OCHFCF₂CF₂CF₂)ₐ—
—(OCHFCF₂—OCF₂CHFCF₂CF₂)ₐ—
—(OCHFCF₂—OCF₂CF₂CHFCF₂)ₐ—
—(OCHFCF₂—OCF₂CF₂CF₂CHF)ₐ—
—(OCHFCF₂—OCH₂CF₂CF₂CF₂)ₐ—
—(OCHFCF₂—OCF₂CH₂CF₂CF₂)ₐ—
—(OCHFCF₂—OCF₂CF₂CH₂CF₂)ₐ—
—(OCHFCF₂—OCF₂CF₂CF₂CH₂)ₐ—
—(OCH₂CF₂—OCF₂CF₂CF₂CF₂)ₐ—
—(OCH₂CF₂—OCHFCF₂CF₂CF₂)ₐ—
—(OCH₂CF₂—OCF₂CHFCF₂CF₂)ₐ—
—(OCH₂CF₂—OCF₂CF₂CHFCF₂)ₐ—
—(OCH₂CF₂—OCF₂CF₂CF₂CHF)ₐ—
—(OCH₂CF₂—OCH₂CF₂CF₂CF₂)ₐ—
—(OCH₂CF₂—OCF₂CH₂CF₂CF₂)ₐ—
—(OCH₂CF₂—OCF₂CF₂CH₂CF₂)ₐ—
—(OCH₂CF₂—OCF₂CF₂CF₂CH₂)ₐ—. The structure (2) is not limited to these specific examples.

In the Formula (2), a is an integer of 1 or more, and satisfies the condition of 2≤(2×a)≤m.

a is preferably 1 to 200, more preferably 1 to 100, and still more preferably 1 to 50.

(OX)ₘ in the Formula (1) may include two or more structures (2). Examples of the form including two or more structures (2) include a form including two or more structures (2) in which at least one of X¹ or X2 in the Formula (2) is different, and a form including two or more structures (2) in which both X¹ and X2 in the Formula (2) are the same with (OX) other than the structures (2) interposed therebetween.

The number of the structures (2) included in (OX)ₘ in the Formula (1) is preferably 1 to 10, more preferably 1 to 6, and still more preferably 2 to 4.

In a case in which (OX)ₘ in the Formula (1) includes a plurality of structures (2), a plurality of a's may be the same or different from each other.

In the Formula (1), it is preferable that (OX)ₘ includes (OC₄F₆)_{b}, and b is an integer of 1 or more. The upper limit value of b is not particularly limited, and is 5 from the viewpoint of decreasing the viscosity of the curable composition. In a case in which (OX)ₘ contains (OC₄F₆)_{b}, the heat resistance of the curable composition is improved.

In the Formula (1), it is preferable that (OX)ₘ includes (OC₂F₄)_{c} and (OCF₂)_{d}. Each of c and d independently represents an integer of 1 or more. d/c is 0.8 or more.

In a case in which d/c is 0.8 or more, the viscosity of the curable composition tends to be decreased. The upper limit value of d/c is not particularly limited. From the viewpoint of ease of synthesis, d/c is preferably 10 or less, and more preferably 8 or less.

The sum of c and d is preferably 5 to 150, and more preferably 10 to 100 from the viewpoint of achieving both a low dielectric constant and a low viscosity.

In the Formula (1), it is preferable that (OX)ₘ includes (OC₃F₆)ₑ, and e is an integer of 1 or more. The upper limit value of e is not particularly limited, and is 30 from the viewpoint of decreasing the viscosity of the curable composition. The number of carbon atoms of the fluoroalkylene group is more than 2, whereby in a case in which (OX)ₘ contains (OC₃F₆)ₑ, the heat resistance of the curable composition is improved. In this regard, the number of carbon atoms of the fluoroalkylene group is less than 4, whereby in a case in which (OX)ₘ contains (OC₃F₆)ₑ, the viscosity of the curable composition tends to be decreased.

The compound A may be a compound represented by the following Formula (3).

M¹ᵣ₁-Y¹-Rf¹-(OX)ₘ—O-Y³ Formula (3)

In the Formula (3),

M¹ represents a polymerizable group (a);

r1 represents an integer of 1 or more;

Y¹ represents a (r1+1)-valent linking group having no fluorine atom; each of X's independently represents a fluoroalkylene group;

m represents an integer of 1 or more; and

Y³ represents a monovalent organic group.

Preferred aspects of M¹, r1, Y¹, Rf¹, X, and m in the Formula (3) are the same as those of M¹, r1, Y¹, Rf¹, X, and m in the Formula (1).

In the Formula (3), Y³ represents a monovalent organic group. Examples of the monovalent organic group represented by Y³ include an alkyl group and an aryl group. The alkyl group may be a linear alkyl group, a branched alkyl group, or an alkyl group having a cyclic structure. Each of the alkyl group and the aryl group may have a substituent. Examples of the substituent include a halogen atom (for example, a fluorine atom), a halogenated alkyl group (for example, a trifluoromethyl group), an alkyl group, an alkoxy group, and a hydroxyl group.

The number of carbon atoms of the alkyl group is preferably 1 to 6, and more preferably 1 to 3.

Among them, Y³ is preferably a fluoroalkyl group in which an alkyl group is substituted with a fluorine atom, and more preferably a perfluoroalkyl group.

The content of the compound A is preferably 15% by mass to 95% by mass, more preferably 40% by mass to 90% by mass, and still more preferably 40% by mass to 70% by mass with respect to the total amount of the curable composition. In a case in which the content of the compound A is 15% by mass or more, the dielectric constant of the resulting cured film tends to be decreased. In this regard, in a case in which the content of the compound A is 95% by mass or less, the viscosity of the curable composition tends to be decreased, and the curability thereof tends to be improved.

The molecular weight of the compound A is preferably 200 to 6000, and more preferably 500 to 5000. In a case in which the molecular weight is 500 or more, the dielectric constant of the resulting cured film tends to be decreased. In this regard, in a case in which the molecular weight is 5000 or less, the viscosity of the curable composition tends to be decreased, and the curability thereof tends to be improved.

In a case in which the molecular weight of the compound A is less than 1000, the molecular weight can be calculated based on the structural formula of the compound. In a case in which the molecular weight of the compound A is more than 1000, the molecular weight can be calculated by determining the number of constituent units from the integral values of ¹H-NMR and ¹⁹F-NMR.

### Polymerization Initiator

The curable composition of the disclosure contains a polymerization initiator. The curable composition may contain one polymerization initiator or two or more polymerization initiators.

The polymerization initiator is selected, if appropriate according to a curing method (photocuring or thermal curing) or the like. Examples of the polymerization initiator include a photopolymerization initiator and a thermal polymerization initiator. The polymerization initiator is preferably a photopolymerization initiator from the viewpoint of ease of forming the cured film. The photopolymerization initiator is preferably a photoradical polymerization initiator or a photoacid generator from the viewpoint of ease of forming the cured film.

Examples of the photoradical polymerization initiator include an acetophenone-based photopolymerization initiator, a benzoin-based photopolymerization initiator, a benzophenone-based photopolymerization initiator, a thioxanthone-based photopolymerization initiator, an α-aminoketone-based photopolymerization initiator, an α-hydroxyketone-based photopolymerization initiator, an α-acyloxime ester, benzyl-(o-ethoxycarbonyl)-α-monoxime, an acylphosphine oxide, a glyoxyester, 3-ketocoumarin, 2-ethylanthraquinone, camphorquinone, tetramethylthiuram sulfide, azobisobutyronitrile, benzoyl peroxide, dialkyl peroxide, and tert-butyl peroxypivalate. Among them, from the viewpoint of sensitivity and compatibility, the photoradical polymerization initiator is preferably an acetophenone-based photopolymerization initiator, a benzoin-based photopolymerization initiator, an α-aminoketone-based photopolymerization initiator, or a benzophenone-based photopolymerization initiator, and more preferably an acetophenone-based photopolymerization initiator.

As the photoacid generator, a known photoacid generator can be used. Examples of the photoacid generator include compounds described in Japanese Patent Application Laid-Open (JP-A) No. 2017-90515. Examples of the photoacid generator include a sulfonate ester, a carboxylic acid ester, and an onium salt. Among them, the photoacid generator is preferably an onium salt.

Examples of the onium salt include sulfonium salts and iodonium salts having anions such as tetrafluoroborate (BF₄⁻), hexafluorophosphate (PF₆⁻), hexafluoroantimonate (SbF₆⁻), hexafluoroarsenate (AsF₆⁻), hexachloroantimonate (SbCl₆⁻), tetraphenylborate, tetrakis(trifluoromethylphenyl)borate, tetrakis(pentafluoromethylphenyl)borate, a perchlorate ion (ClO₄⁻), a trifluoromethanesulfonic acid ion (CF₃SO₃⁻), a fluorosulfonic acid ion (FSO₃⁻), a toluenesulfonic acid ion, a trinitrobenzenesulfonic acid anion, and a trinitrotoluenesulfonic acid anion.

Examples of the sulfonium salt include triphenylsulfonium hexafluoroarsenate, triphenylsulfonium hexafluoroborate, triphenylsulfonium tetrafluoroborate, triphenylsulfonium tetrakis(pentafluorobenzyl)borate, methyldiphenylsulfonium tetrafluoroborate, methyldiphenylsulfonium tetrakis(pentafluorobenzyl)borate, dimethylphenylsulfonium hexafluorophosphate, triphenylsulfonium hexafluorophosphate, triphenylsulfonium hexafluoroantimonate, diphenylnaphthylsulfonium hexafluoroarsenate, tritoylsulfonium hexafluorophosphate, anicyldiphenylsulfonium hexafluoroantimonate, 4-butoxyphenyldiphenylsulfonium tetrafluoroborate, 4-butoxyphenyldiphenylsulfonium tetrakis(pentafluorobenzyl)borate, 4-chlorophenyldiphenylsulfonium hexafluoroantimonate, tris(4-phenoxyphenyl)sulfonium hexafluorophosphate, di(4-ethoxyphenyl)methylsulfonium hexafluoroarsenate, 4-acetylphenyldiphenylsulfonium tetrafluoroborate, 4-acetylphenyldiphenylsulfonium tetrakis(pentafluorobenzyl)borate, tris(4-thiomethoxyphenyl)sulfonium hexafluorophosphate, di(methoxysulfonylphenyl)methylsulfonium hexafluoroantimonate, di(methoxynaphthyl)methylsulfonium tetrafluoroborate, di(methoxynaphthyl)methylsulfonium tetrakis (pentafluorobenzyl)borate, di(carbomethoxyphenyl)methylsulfonium hexafluorophosphate, (4-octyloxyphenyl)diphenylsulfonium tetrakis(3,5-bis-trifluoromethylphenyl)borate, tris(dodecylphenyl)sulfonium tetrakis(3,5-bis-trifluoromethylphenyl)borate, 4-acetamidophenyldiphenylsulfonium tetrafluoroborate, 4-acetamidophenyldiphenylsulfonium tetrakis(pentafluorobenzyl)borate, dimethylnaphthylsulfonium hexafluorophosphate, trifluoromethyldiphenylsulfonium tetrafluoroborate, trifluoromethyldiphenylsulfonium tetrakis(pentafluorobenzyl)borate, phenylmethylbenzylsulfonium hexafluorophosphate, 10-methylphenoxathiinium hexafluorophosphate, 5-methylthianthrenium hexafluorophosphate, 10-phenyl-9,9-dimethylthioxanthenium hexafluorophosphate, 10-phenyl-9-oxothioxanthenium tetrafluoroborate, 10-phenyl-9-oxothioxanthenium tetrakis(pentafluorobenzyl)borate, 5-methyl-10-oxothiatrenium tetrafluoroborate, 5-methyl-10-oxothiatrenium tetrakis(pentafluorobenzyl)borate, and 5-methyl-10,10-dioxothiatrenium hexafluorophosphate.

Examples of the iodonium salt include (4-n-desiloxyphenyl)phenyliodonium hexafluoroantimonate, [4-(2-hydroxy-n-tetradecyl oxy)phenyl]phenyliodonium hexafluoroantimonate, [4-(2-hydroxy-n-tetradecyloxy)phenyl]phenyliodonium trifluorosulfonate, [4-(2-hydroxy-n-tetradecyl oxy)phenyl]phenyliodonium hexafluorophosphate, [4-(2-hydroxy-n-tetradecyl oxy)phenyl]phenyliodonium tetrakis(pentafluorophenyl)borate, bis(4-t-butylphenyl)iodonium hexafluoroantimonate, bis(4-t-butylphenyl)iodonium hexafluorophosphate, bis(4-t-butylphenyl)iodonium trifluorosulfonate, bis(4-t-butylphenyl)iodonium tetrafluoroborate, bis(dodecylphenyl)iodonium hexafluoroantimonate, bis(dodecylphenyl)iodonium tetrafluoroborate, bis(dodecylphenyl)iodonium hexafluorophosphate, bis(dodecylphenyl)iodonium trifluoromethylsulfonate, di(dodecylphenyl)iodonium hexafluoroantimonate, di(dodecylphenyl)iodonium triflate, diphenyliodonium bisulfate, 4,4′-dichlorodiphenyliodonium bisulfate, 4,4′-dibromodiphenyliodonium bisulfate, 3,3′-dinitrodiphenyliodonium bisulfate, 4,4′-dimethyldiphenyliodonium bisulfate, 4,4′-bissuccinimidodiphenyliodonium bisulfate, 3-nitrodiphenyliodonium bisulfate, 4,4′-dimethoxydiphenyliodonium bisulfate, bi s(dodecylphenyl)iodonium tetrakis(pentafluorophenyl)borate, (4-octyloxyphenyl)phenyliodonium tetrakis(3,5-bis-trifluoromethylphenyl)borate, (tolylcumyl)iodonium tetrakis(pentafluorophenyl)borate (CH₃C₆H₄)2I⁻(SO₂CF₃)₃ as disclosed in U.S. Pat. No. 5,554,664, (C₆H₅)2I⁻B(C₆F₅)₄ as disclosed in U.S. Pat. No. 5,514,728, and those disclosed in U.S. Pat. No. 5,340,898.

Examples of the other onium salt include an aromatic diazonium salt. Examples of the aromatic diazonium salt include p-methoxybenzenediazonium hexafluoroantimonate.

As the thermal polymerization initiator, a known polymerization initiator can be used. Examples of the thermal polymerization initiator include an azo compound and an organic peroxide. Examples of the azo compound include 2,2′-azobis(isobutyronitrile). Examples of the organic peroxide include benzoyl peroxide.

The content of the polymerization initiator in the curable composition is preferably 0.5% by mass to 10% by mass, more preferably 1% by mass to 8% by mass, and still more preferably 1% by mass to 6% by mass with respect to the total amount of the curable composition.

### Compound B

The curable composition of the disclosure contains a compound B having a polymerizable group different from the polymerizable group (a). The curable composition may contain one compound B or two or more compounds B.

The polymerizable group of the compound B is not particularly limited as long as it is a polymerizable group different from the polymerizable group (a) of the compound A, and may be a vinylphenyl group, a vinylphenyloxy group, a vinylbenzyloxy group, a vinyloxy group, a vinyloxycarbonyl group, a vinylamino group, a vinylaminocarbonyl group, a vinylthio group, an allyloxy group, an allyloxycarbonyl group, an allylamino group, an allylaminocarbonyl group, an allylthio group, an epoxy group, or an epoxycycloalkyl group mentioned as examples of the polymerizable group (a). From the viewpoint of ease of curing, the polymerizable group in the compound B is preferably at least one selected from the group consisting of a (meth)acryloyl group and a maleimide group, and more preferably a (meth)acryloyl group.

The compound B is preferably at least one selected from the group consisting of a compound B1 having a polymerizable group different from the polymerizable group (a) and having an oxyfluoroalkylene group; a compound B2 having two or more polymerizable groups and having no oxyfluoroalkylene group; and a compound B3 having one polymerizable group and having no oxyfluoroalkylene group.

In a case in which the compound A has two or more polymerizable groups a, the compound B has a polymerizable group different from all of the two or more polymerizable groups a.

### Compound B1 Having Polymerizable Group Different From Polymerizable Group (a) and Having Oxyfluoroalkylene Group

The compound B1 is a compound having a polymerizable group different from the polymerizable group (a) and having an oxyfluoroalkylene group. The compound B1 is preferably a compound represented by the following Formula (4).

M³ᵣ₃-Y³-Rf³-(OZ)ₚ—O-Rf⁴-Y⁴-M⁴ᵣ₄ Formula (4)

In the Formula (4),

each of M³ and M⁴ independently represents a polymerizable group different from the polymerizable group (a);

each of r3 and r4 independently represents an integer of 1 or more;

Y³ represents a (r3+1)-valent linking group having no fluorine atom;

Y⁴ represents a (r4+1)-valent linking group having no fluorine atom;

Rf³ represents a fluoroalkylene group in which a fluorine atom is bonded to a carbon atom bonded to Y³;

Rf³ represents a fluoroalkylene group in which a fluorine atom is bonded to a carbon atom bonded to Y⁴;

each of Z's independently represents a fluoroalkylene group; and

p represents an integer of 1 or more.

Preferred aspects of r3, Y³, Rf³, Z, p, Rf⁴, Y⁴, and r4 in the Formula (4) are the same as the preferred aspects of r1, Y¹, Rf¹, X, m, Rf², Y², and r2 in the Formula (1).

That is, in the Formula (4), (OZ)ₚ includes a structure in which continuous (OZ) is represented by the following Formula (5);

p represents an integer of 2 or more;

—(OZ¹-OZ²)_{q}— Formula (5)

wherein:

in the Formula (5),

Z¹ represents a fluoroalkylene group having 1 to 6 carbon atoms;

Z² represents a fluoroalkylene group having 1 to 6 carbon atoms which is different from Z¹; and

q represents an integer of 1 or more, and satisfies 2≤(2×q)≤p.

In the Formula (4), it is preferable that (OZ)ₚ includes (OC₄F₆)_{b1}, and b1 is an integer of 1 or more. The upper limit value of b 1 is not particularly limited, and is 5 from the viewpoint of decreasing the viscosity of the curable composition.

In the Formula (4), (OZ)ₚ includes (OC₂F₄)_{c1} and (OCF₂)_{d1}. Each of c1 and d1 independently represents an integer of 1 or more. d1/c1 is preferably 0.8 or more, and more preferably 2 or more from the viewpoint of decreasing the viscosity of the curable composition. From the viewpoint of ease of synthesis, d1/c1 is preferably 10 or less, and more preferably 8 or less.

In the Formula (4), it is preferable that (OZ)ₚ includes (OC₃F₆)ₑ₁, and e1 is an integer of 1 or more. The upper limit value of e1 is not particularly limited, and is 30 from the viewpoint of decreasing the viscosity of the curable composition.

In the Formula (4), it is preferable that each of M³ and M⁴ independently represents a (meth)acryloyl group or a maleimide group. In a case in which there are a plurality of M³'s and M⁴'s, M³'s and M⁴'s preferably represent the same polymerizable group, and more preferably a (meth)acryloyl group, from the viewpoint of ease of production.

In a case in which the curable composition contains the compound B1, the content of the compound B1 is preferably 20% by mass to 60% by mass with respect to the total amount of the curable composition.

### Compound B2 Having Two or More Polymerizable Groups and Having No Oxyfluoroalkylene Group

The compound B2 is a compound having two or more polymerizable groups and having no oxyfluoroalkylene group. All of the two or more polymerizable groups of the compound B2 are polymerizable groups different from the polymerizable group (a).

Examples of the compound B2 include a polyfunctional (meth)acrylate compound, a polyfunctional maleimide, and a polyfunctional vinyl ether. Among them, from the viewpoint of curability, the compound B2 is preferably at least one selected from the group consisting of a polyfunctional (meth)acrylate compound and a polyfunctional maleimide, and more preferably a polyfunctional (meth)acrylate. The compound B2 may have a fluorine atom.

The number of the polymerizable groups of the compound B2 is preferably 3 or more from the viewpoint of curability. The number of the polymerizable groups of the compound B2 is preferably 6 or less, and more preferably 4 or less, from the viewpoint of decreasing the viscosity of the curable composition.

The two or more polymerizable groups of the compound B2 may be different from each other, and are preferably the same from the viewpoint of curability.

Examples of the polyfunctional (meth)acrylate include ethylene glycol di(meth)acrylate, diethylene glycol di(meth)acrylate, triethylene glycol di(meth)acrylate, polyethylene glycol di(meth)acrylate, propylene glycol di(meth)acrylate, dipropylene glycol di(meth)acrylate, tripropylene glycol di(meth)acrylate, polypropylene glycol di(meth)acrylate, butylene glycol di(meth)acrylate, tetraethylene glycol di(meth)acrylate, neopentyl glycol di(meth)acrylate, 3-methyl-1,5-pentanediol di(meth)acrylate, hexanediol di(meth)acrylate, heptanediol di(meth)acrylate, EO-modified neopentyl glycol di(meth)acrylate, PO-modified neopentyl glycol di(meth)acrylate, EO-modified hexanediol di(meth)acrylate, PO-modified hexanediol di(meth)acrylate, octanediol di(meth)acrylate, nonanediol di(meth)acrylate, decanediol di(meth)acrylate, dodecanediol di(meth)acrylate, 1,6-hexanediol di(meth)acrylate, glycerol di(meth)acrylate, pentaerythritol di(meth)acrylate, ethylene glycol diglycidyl ether di(meth)acrylate, diethylene glycol diglycidyl ether di(meth)acrylate, tricyclodecane dimethanol di(meth)acrylate, glycerol tri(meth)acrylate, trimethylolethane tri(meth)acrylate, trimethylolpropane tri(meth)acrylate, trimethylolpropane EO-added tri(meth)acrylate, pentaerythritol tri(meth)acrylate, pentaerythritol tetra(meth)acrylate, dipentaerythritol tetra(meth)acrylate, dipentaerythritol penta(meth)acrylate, dipentaerythritol hexa(meth)acrylate, tri(meth)acryloyloxyethoxytrimethylolpropane, glycerol polyglycidyl ether poly(meth)acrylate, and tris(2-acryloyloxyethyl)isocyanurate.

The polyfunctional (meth)acrylate may be an urethane (meth)acrylate which is a reactant of a bifunctional isocyanate compound and a hydroxyl group-containing polyfunctional (meth)acrylate.

The polyfunctional (meth)acrylate may be an epoxy (meth)acrylate which is a reaction product of (meth)acrylic acid and an epoxy resin. Examples of the epoxy resin include a bisphenol A type epoxy resin and a cresol novolac type epoxy resin.

Examples of the polyfunctional maleimide include 1,2-bis(maleimide)ethane, 1,4-bis(maleimide)butane, 1,6-bis(maleimide)hexane, and 4,4′-bismaleimide diphenylmethane.

Examples of the polyfunctional vinyl ether include 1,4-butanediol divinyl ether, ethylene glycol divinyl ether, diethylene glycol divinyl ether, triethylene glycol divinyl ether, polyethylene glycol divinyl ether, propylene glycol divinyl ether, butylene glycol divinyl ether, hexanediol divinyl ether, 1,4-cyclohexanedimethanol divinyl ether, bisphenol A alkylene oxide divinyl ether, bisphenol F alkylene oxide divinyl ether, trimethylol ethane trivinyl ether, trimethylol propane trivinyl ether, ditrimethylol propane tetravinyl ether, glycerin trivinyl ether, pentaerythritol tetravinyl ether, dipentaerythritol pentavinyl ether, dipentaerythritol hexavinyl ether, EO-added trimethylolpropane trivinyl ether, PO-added trimethylolpropane trivinyl ether, EO-added ditrimethylolpropane tetravinyl ether, PO-added ditrimethylolpropane tetravinyl ether, EO-added pentaerythritol tetravinyl ether, PO-added pentaerythritol tetravinyl ether, EO-added dipentaerythritol hexavinyl ether, and PO-added dipentaerythritol hexavinyl ether.

In a case in which the curable composition contains the compound B2, the content of the compound B2 is preferably 5% by mass to 40% by mass with respect to the total amount of the curable composition.

### Compound B3 Having One Polymerizable Group and Having No Oxyfluoroalkylene Group

The compound B3 is a compound having one polymerizable group and having no oxyfluoroalkylene group.

Examples of the compound B3 include a monofunctional (meth)acrylate, a monofunctional maleimide, a monofunctional (meth)acrylamide, a monofunctional aromatic vinyl compound, a monofunctional vinyl ether, and a monofunctional N-vinyl compound. Among them, from the viewpoint of curability, the compound B3 is preferably at least one selected from the group consisting of a monofunctional (meth)acrylate and a monofunctional maleimide, and more preferably a monofunctional (meth)acrylate. The compound B3 may have a fluorine atom.

Examples of the monofunctional (meth)acrylate include methyl (meth)acrylate, ethyl (meth)acrylate, propyl (meth)acrylate, n-butyl (meth)acrylate, hexyl (meth)acrylate, 2-ethylhexyl (meth)acrylate, tert-octyl (meth)acrylate, isoamyl (meth)acrylate, decyl (meth)acrylate, isodecyl (meth)acrylate, lauryl (meth)acrylate, stearyl (meth)acrylate, isostearyl (meth)acrylate, cyclohexyl (meth)acrylate, 4-n-butylcyclohexyl (meth)acrylate, 4-tert-butylcyclohexyl (meth)acrylate, bornyl (meth)acrylate, isobornyl (meth)acrylate, 2-ethylhexyl diglycol (meth)acrylate, butoxyethyl (meth)acrylate, 2-chloroethyl (meth)acrylate, 4-bromobutyl (meth)acrylate, cyanoethyl (meth)acrylate, benzyl (meth)acrylate, butoxymethyl (meth)acrylate, 3-methoxybutyl (meth)acrylate, 2-(2-methoxy-ethoxy)ethyl (meth)acrylate, 2-(2-butoxyethoxy)ethyl (meth)acrylate, 2,2,2-tetrafluoroethyl (meth)acrylate, 1H, 1H, 2H, 2H-perfluorodecyl (meth)acrylate, 4-butylphenyl (meth)acrylate, phenyl (meth)acrylate, 2,4,5-tetramethylphenyl (meth)acrylate, 4-chlorophenyl (meth)acrylate, 2-phenoxymethyl (meth)acrylate, 2-phenoxyethyl (meth)acrylate, glycidyl (meth)acrylate, glycidyloxybutyl (meth)acrylate, glycidyloxyethyl (meth)acrylate, glycidyloxypropyl (meth)acrylate, tetrahydrofurfuryl (meth)acrylate, 2-hydroxy ethyl (meth)acrylate, 3-hydroxypropyl (meth)acrylate, 2-hydroxypropyl (meth)acrylate, 2-hydroxybutyl (meth)acrylate, 3-hydroxybutyl (meth)acrylate, 4-hydroxybutyl (meth)acrylate, cyclic trimethylolpropane formal (meth)acrylate, phenyl glycidyl ether (meth)acrylate, dimethylaminoethyl (meth)acrylate, diethylaminoethyl (meth)acrylate, dimethylaminopropyl (meth)acrylate, diethylaminopropyl (meth)acrylate, trimethoxysilylpropyl (meth)acrylate, trimethylsilylpropyl (meth)acrylate, polyethylene oxide monomethyl ether (meth)acrylate, polyethylene oxide (meth)acrylate, polyethylene oxide monoalkyl ether (meth)acrylate, dipropylene glycol (meth)acrylate, polypropylene oxide monoalkyl ether (meth)acrylate, 2-methacryloyoxyethyl succinic acid, 2-methacryloyloxyhexahydrophthalic acid, 2-methacryloyloxyethyl-2-hydroxypropylphthalate, ethoxydiethylene glycol (meth)acrylate, butoxydiethylene glycol (meth)acrylate, trifluoroethyl (meth)acrylate, perfluorooctylethyl (meth)acrylate, 2-hydroxy-3-phenoxypropyl (meth)acrylate, ethylene oxide (EO)-modified phenol (meth)acrylate, EO-modified cresol (meth)acrylate, EO-modified nonylphenol (meth)acrylate, propylene oxide (PO)-modified nonylphenol (meth)acrylate, EO-modified-2-ethylhexyl (meth)acrylate, dicyclopentenyl (meth)acrylate, dicyclopentenyloxyethyl (meth)acrylate, dicyclopentanyl (meth)acrylate, (3-ethyl-3-oxetanylmethyl) (meth)acrylate, phenoxyethylene glycol (meth)acrylate, 2-carboxyethyl (meth)acrylate, and 2-(meth)acryloyloxyethyl succinate.

Examples of the monofunctional maleimide include N-phenylmaleimide.

Examples of the monofunctional (meth)acrylamide include (meth)acrylamide, N-methyl (meth)acrylamide, N-ethyl (meth)acrylarnide, N-propyl (meth)acrylamide, N-n-butyl (meth)acrylamide, N-t-butyl (meth)acrylamide, N-butoxymethyl (meth)acrylamide, N-isopropyl (meth)acrylamide, N-methylol (meth)acrylamide, N,N-dimethyl (meth)acrylamide, N,N-diethyl (meth)acrylamide, and (meth)acryloylmorpholine.

Examples of the monofunctional aromatic vinyl compound include styrene, dimethylstyrene, trimethylstyrene, isopropylstyrene, chloromethylstyrene, methoxystyrene, acetoxystyrene, chlorostyrene, dichlorostyrene, bromostyrene, vinyl benzoic acid methyl ester, 3-methylstyrene, 4-methylstyrene, 3-ethylstyrene, 4-ethylstyrene, 3-propylstyrene, 4-propylstyrene, 3-butylstyrene, 4-butylstyrene, 3-hexylstyrene, 4-hexylstyrene, 3-octylstyrene, 4-octylstyrene, 3-(2-ethylhexyl)styrene, 4-(2-ethylhexyl)styrene, allylstyrene, isopropertylstyrene, butenylstyrene, octenylstyrene, 4-t-butoxycarbonylstyrene, and 4-t-butoxystyrene.

Examples of the monofunctional vinyl ether include methyl vinyl ether, ethyl vinyl ether, propyl vinyl ether, n-butyl vinyl ether, t-butyl vinyl ether, 2-ethylhexyl vinyl ether, n-nonyl vinyl ether, lauryl vinyl ether, cyclohexyl vinyl ether, cyclohexylmethyl vinyl ether, 4-methylcyclohexylmethyl vinyl ether, benzyl vinyl ether, dicyclopentenyl vinyl ether, 2-dicyclopentenoxyethyl vinyl ether, methoxyethyl vinyl ether, ethoxyethyl vinyl ether, butoxyethyl vinyl ether, methoxyethoxyethyl vinyl ether, ethoxyethoxyethyl vinyl ether, methoxypolyethylene glycol vinyl ether, tetrahydroflufuiyl vinyl ether, 2-hydroxyethyl vinyl ether, 2-hydroxypropyl vinyl ether, 4-hydroxybutyl vinyl ether, 4-hydroxymethylcyclohexylmethyl vinyl ether, diethyleneglycol monovinyl ether, polyethylene glycol vinyl ether, chloroethyl vinyl ether, chlorobutyl vinyl ether, chloroethoxyethyl vinyl ether, phenylethyl vinyl ether, and phenoxypolyethylene glycol vinyl ether.

Examples of the monofunctional N-vinyl compound include N-vinyl-ε-caprolactam and N-vinylpyrrolidone.

In a case in which the curable composition contains the compound B3, the content of the compound B3 is preferably 5% by mass to 50% by mass with respect to the total amount of the curable composition.

### Silane Coupling Agent

The curable composition of the disclosure preferably further contains a silane coupling agent. In a case in which the curable composition contains the silane coupling agent, adhesion between the substrate and the cured film is improved.

The silane coupling agent preferably has a polymerizable group. Examples of the polymerizable group of the silane coupling agent include a vinyl group, a (meth)acryloyl group, and a vinylphenyl group. Among them, the polymerizable group is preferably a (meth)acryloyl group.

Examples of the silane coupling agent having a polymerizable group include vinyltrimethoxysilane, vinyltriethoxysilane, 3-methacryloxypropylmethyldimethoxysilane, 3-methacryloxypropyltrimethoxysilane, 3-methacryloxypropylmethyldiethoxysilane, 3-methacryloxypropyltriethoxysilane, 3-acryloxypropyltrimethoxysilane, and p-styryltrimethoxysilane.

In a case in which the curable composition of the disclosure contains the silane coupling agent, the content of the silane coupling agent is preferably 1% by mass to 10% by mass, and more preferably 2% by mass to 8% by mass with respect to the total amount of the curable composition.

### Organic Solvent

The curable composition of the disclosure preferably contains substantially no organic solvent from the viewpoint of ease of production of the cured film. Specifically, the content of the organic solvent is preferably 1% by mass or less, and more preferably 0.5% by mass or less with respect to the total amount of the curable composition.

### Other Components

The curable composition of the disclosure may further contain an additive other than the above components as long as the effect of the disclosure is not impaired. Examples of the additive include a polymerization inhibitor, a metal (for example, platinum and tin) catalyst, and a surface tension modifier (surfactant).

### Physical Properties

The viscosity of the curable composition of the disclosure is preferably 50 mPa·s or less, more preferably 40 mPa·s or less, and still more preferably 25 mPa·s or less from the viewpoint of dischargeability in a case in which the curable composition is applied by an inkjet printing method. The lower limit value of the viscosity is not particularly limited, and is, for example, 1 mPa·s.

The viscosity is measured using a viscometer, and can be obtained, for example, by measuring a dynamic viscoelasticity at a shear rate of 10 s⁻¹ at 25° C. using a dynamic viscoelasticity measuring device (product name “PHYSICAMCR301”, manufactured by Anton Paar GmbH).

### Method of Producing Cured Film

A method of producing a cured film of the disclosure preferably includes the steps of: applying the curable composition onto a substrate; and irradiating the curable composition with an active energy ray.

### Step of Applying Curable Composition

The method of applying the curable composition onto the substrate is not particularly limited, and examples thereof include a spin coating method, a roll coating method, a spray coating method, a dipping method, and an inkjet method.

The type of the substrate is not particularly limited, and examples thereof include a quartz glass substrate, a silicon substrate, an SiN substrate, a PET substrate, a polyimide substrate, and a PEN substrate.

### Step of Irradiating Curable Composition with Active Energy Ray

Examples of the active energy ray include an α-ray, a γ-ray, an X-ray, an ultraviolet ray, a visible ray, and an electron beam. Among them, from the viewpoint of safety and cost, the active energy ray is more preferably an ultraviolet ray.

The exposure amount of the ultraviolet ray is preferably 100 mJ/cm² to 8000 mJ/cm², and more preferably 500 mJ/cm² to 5000 mJ/cm².

Examples of a light source for ultraviolet ray irradiation include a mercury lamp, a gas laser, a solid laser, a metal halide lamp, an ultraviolet fluorescent lamp, a UV-LED (light emitting diode), and a UV-LD (laser diode). Among them, the light source for ultraviolet ray irradiation is preferably a high-pressure mercury lamp, an intermediate-pressure mercury lamp, a low-pressure mercury lamp, a metal halide lamp, or a UV-LED.

### Other Steps

The method of producing a cured film of the disclosure may further include the step of irradiating the curable composition with an active energy ray and then heating the curable composition irradiated with the active energy ray.

A heating temperature and a heating time are not particularly limited, and are, for example, 70° C. to 120° C., and 1 minute to 3 hours.

### Cured Film

The cured film of the disclosure is a cured product of the curable composition. The cured film of the disclosure is produced, for example, by the above production method.

### Physical Properties

The dielectric constant of the cured film of the disclosure is preferably 3.0 or less, more preferably 2.9 or less, and still more preferably 2.8 or less.

The dielectric constant can be obtained as a relative dielectric constant at 100 kHz, for example, by performing capacitance-to-voltage (CV) measurement using a mercury prober (product name “SSM-495”, manufactured by SSM Inc.).

The dielectric constant may be obtained, for example, by measuring a relative dielectric constant at 10 GHz at room temperature (25° C.) using a SPDR method dielectric constant measuring device (manufactured by QEWD).

The refractive index of the cured film of the disclosure is preferably 1.3 to 1.7, and more preferably 1.3 to 1.5.

The refractive index is measured by the following method using, for example, a refractometer. First, the refractive indexes of the cured film to lights having wavelengths of 473 nm, 594 nm, and 658 nm are measured at 25° C. using a refractometer (product name “PRISM COUPLER: 2010/M”, manufactured by Metricon). The refractive index is calculated as a refractive index to light having a wavelength of 589 nm using a Metricon Fit attached to the device.

The transmittance of the cured film of the disclosure is, for example, preferably 80% to 100%, and more preferably 90% to 100%

The transmittance is calculated as a light transmittance to light having a wavelength of 410 nm using, for example, an ultraviolet-visible-near-infrared spectrophotometer (product name “SOLID SPEC-3700”, manufactured by Shimadzu Corporation).

### Element

An element of the disclosure includes, for example, an OLED organic layer including a light-emitting layer, and a thin film sealing layer disposed on the OLED organic layer. In the thin film sealing layer, a SiN film and the cured film are alternately laminated.

The element of the disclosure is suitable for a sensor. For example, a touch sensor electrode may be disposed on the thin film sealing layer to form a touch panel.

The element of the disclosure is suitable for optics.

### Display Device

An optical element which is the element of the disclosure is suitably used for a display device such as a liquid crystal display device or an organic light emitting element display device.

### EXAMPLES

Hereinafter, the disclosure will be described more specifically with reference to Examples, but the disclosure is not limited to the following Examples as long as the gist of the disclosure is not exceeded.

Compounds A1 to A7, and compounds B11 and B12 used in Examples and Comparative Examples were synthesized.

### Synthesis of Compound A1

### Example 1-1

A compound 1-1 was obtained according to the method described in Example 1-1 of Examples of WO2013-121984.

### Compound 1-1

CF₂=CFO—CF₂CF₂CF₂CH₂OH

### Example 1-2

In a 100 mL stainless steel reactor, 100 g of the compound 1-1 obtained in Example 1-1 was placed, followed by stirring at 175° C. for 200 hours. The resulting organic phase was concentrated to obtain 62 g of a compound 1-2.

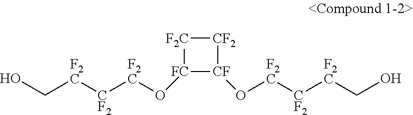

### Example 1-3

To a 200 mL four-necked flask, 10 g of the compound 1-2 obtained in Example 1-2, 20 mL of ASAHIKLIN AC-6000 (fluorine-based solvent, manufactured by AGC Inc.), and 5.9 g of cesium carbonate were added, followed by stirring at 60° C. for 30 minutes. Thereafter, the temperature of the reaction system was cooled to room temperature, and 2.7 g of chloromethylstyrene (meta/para mixture: manufactured by Tokyo Chemical Industry Co., Ltd.) was added thereto, followed by stirring at 70° C. for 12 hours. Thereafter, methanol was added to the mixture, and an organic layer was then separated. The resulting organic layer was further washed, and concentrated. The resulting crude product was purified by silica gel column chromatography to obtain 8.9 g of a compound A1.

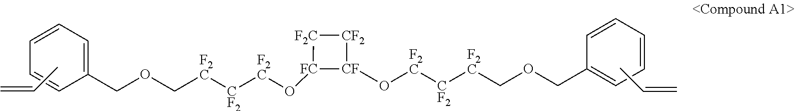

### Synthesis of Compound A2

### Example 2-1

A compound A2 was obtained in the same manner as in Example 1-3 except that FOMBLIN D2 (manufactured by Solvay Corporation) was used in place of the compound 1-2. The average value of the numbers of repetitions c+d was 15, and d/c≈1 was set.

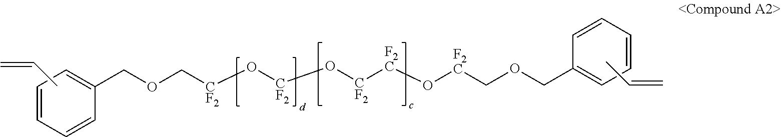

### Synthesis of Compound A3

### Example 3-1

A compound A3 was obtained in the same manner as in Example 1-3 except that FLUOROLINK D4000 (manufactured by Solvay Corporation) was used in place of the compound 1-2. The average value of the numbers of repetitions c+d was 44, and d/c≈1 was set.

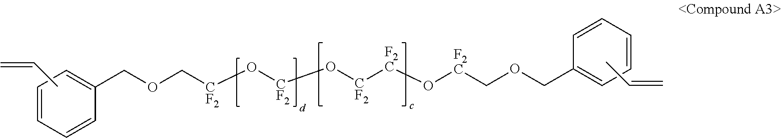

### Synthesis of Compound A4

### Example 4-1

A compound 4-1 was synthesized in the same manner as in Synthesis Examples 1 to 4 of Japanese Patent No. 6024816.

### Compound 4-1

CH₃OCOCF₂—(OCF₂)_{d}—(OCF₂CF₂)_{c}—OCF₂CO₂CH₃

In the Formula, d is an average of 42, and c is an average of 10.

### Example 4-2

To a 500 mL three-necked recovery flask, 20 g of the compound 4-1 obtained in Synthesis Example 4-1, 20 mL of THF, 20 mL of ASAHIKLIN AC-2000 (fluorine-based solvent, manufactured by AGC Inc., hereinafter referred to as “AC-2000”), and 1.2 g of sodium borohydride were added, followed by stirring. 0.5 mL of methanol was added to the mixture, followed by stirring overnight at room temperature. Thereafter, a 1 mol/L aqueous hydrochloric acid solution and Asahikrine AE-3000 (1,1,2,2-tetrafluoroethyl-2,2,2-trifluoroethyl ether, manufactured by AGC Inc., hereinafter referred to as “AE-3000”) were added to the mixture, and the solution was separated. The resulting organic layer was concentrated. The resulting crude product was purified by silica gel column chromatography to obtain 19 g of a compound 4-2. The average value of the numbers of repetitions c+d was 52, and d/c≈4 was set.

### Compound 4-2

HOCH₂CF₂—(OCF₂)_{d}—(OCF₂CF₂)_{c}—OCF₂CH₂OH

### Example 4-3

A compound A4 was obtained in the same manner as in Example 1-3 except that the compound 4-2 obtained in Example 4-2 was used in place of the compound 1-2. The average value of the numbers of repetitions c+d was 52, and d/c≈4 was set.

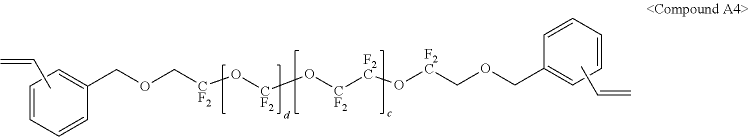

### Synthesis of Compound A5

### Example 5-1

In a 500 mL recovery flask, 10 g of the compound 1-2 obtained in Example 1-2 and 2.4 g of potassium carbonate were placed, followed by stirring at 120° C. 84 g of the compound 1-1 was added to the mixture, followed by stirring at 120° C. for 2 hours. The temperature was returned to 25° C. 85 g of AC-2000 and 85 g of hydrochloric acid were added to the mixture, and the solution was separated. The organic layer was concentrated. The resulting crude reaction solution was purified by column chromatography to obtain 45 g of a compound 5-1. The average value of the numbers of repetitions m+n was 14.

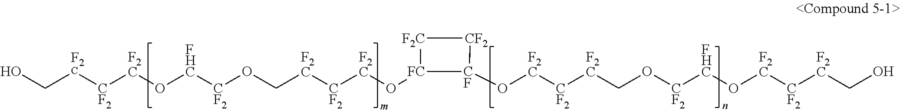

### Example 5-2

To a 50 mL recovery flask to which a reflux condenser was connected, 20 g of the compound 5-1 obtained in Example 5-1, 6.2 g of a sodium fluoride powder, 20 g of AC-2000, and 10 g of CF₃CF₂CF₂OCF(CF₃)COF were added. Under a nitrogen atmosphere, the mixture was stirred at 50° C. for 24 hours. After cooling to room temperature, the sodium fluoride powder was removed with a pressure filtration machine. Excess CF₃CF₂CF₂OCF(CF₃)COF and AC-2000 were distilled off under reduced pressure to obtain 22.5 g of a compound 5-2. The average value of the numbers of repetitions m+n was 14.

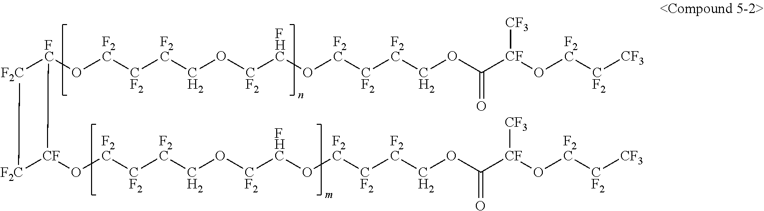

### Example 5-3

In a 500 mL nickel reactor, 250 mL of ClCF₂CFClCF₂OCF₂CF₂Cl (hereinafter referred to as “CFE-419”) was placed, followed by bubbling with nitrogen gas. After the oxygen gas concentration was sufficiently decreased, bubbling with 20 vol % fluorine gas diluted with nitrogen gas was performed for 1 hour. A CFE-419 solution (concentration: 10%, compound 1E: 20 g) of the compound 5-2 obtained in Example 5-2 was charged over 3 hours. The ratio of the introduction rate (mol/hour) of fluorine gas to the introduction rate (mol/hour) of hydrogen atoms in the compound 1E was controlled to be 2:1. After the completion of the charge of the compound 5-2, a CFE-419 solution (concentration: 0.1%, benzene: 0.1 g) of benzene was intermittently charged. After the completion of the charge of benzene, bubbling with fluorine gas was performed for 1 hour, and finally the inside of the reactor was sufficiently replaced with nitrogen gas. The solvent was distilled off to obtain 21 g of a compound 5-3. The average value of the numbers of repetitions m+n was 14.

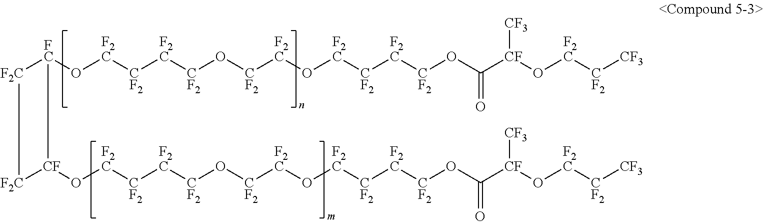

### Example 5-4

In a 50 mL recovery flask, 20 g of the compound 5-3 obtained in Example 5-3, 1.8 g of sodium fluoride, and 20 mL of AC-2000 were placed in the recovery flask, followed by stirring in an ice bath. 1.4 g of methanol was placed, followed by stirring at 25° C. for 1 hour. The mixture was subjected to filtration, and the filtrate was then purified by column chromatography. 15 g of a compound 5-4 was obtained. The average value of the numbers of repetitions m+n was 14.

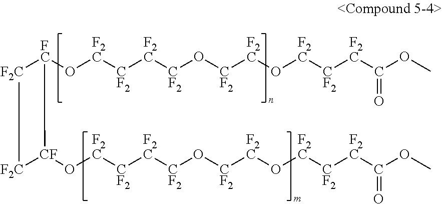

### Example 5-5

To a 500 mL three-necked recovery flask, 14 g of the compound 5-4 obtained in Synthesis Example 5-4, 20 mL of THF, 20 mL of AC-2000, and 1.0 g of sodium borohydride were added, followed by stirring. 0.4 mL of methanol was added to the mixture, followed by stirring overnight at room temperature. Thereafter, a 1 mol/L aqueous hydrochloric acid solution and AE-3000 were added to the mixture, and the solution was separated. The resulting organic layer was concentrated. The resulting crude product was purified by silica gel column chromatography to obtain 14 g of a compound 5-5. The average value of the numbers of repetitions m+n was 14.

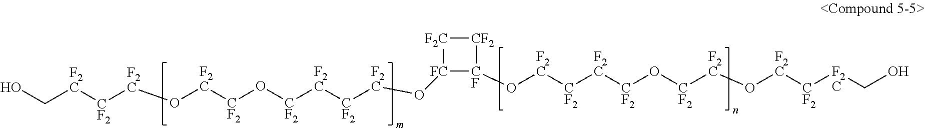

### Example 5-6

A compound A5 was obtained in the same manner as in Example 1-3 except that the compound 5-5 was used in place of the compound 1-2. The average value of the numbers of repetitions m+n was 14.

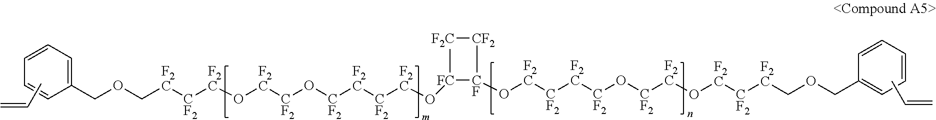

### Synthesis of Compound A6

### Example 6-1

A compound 6-1 was obtained according to the method described in Example 1 of WO2008/026707, and then reacted with methanol to obtain a compound 6-2.

### Compound 6-1

CF₃CF₂OCF₂CF₂OCF₂C(O)F

### Compound 6-2

CF₃CF₂OCF₂CF₂OCF₂C(O)OCH₃

### Example 6-2

3.2 g of sodium borohydride and 200 mL of AC-2000 were added to a 500 mL three-necked recovery flask, followed by stirring under ice cooling. Then, 20 g of the compound 6-2 obtained in Example 6-1 and 2.6 g of methanol were slowly added to the mixture followed by stirring overnight at room temperature after the completion of the addition. Thereafter, a 1 mol/L aqueous hydrochloric acid solution and AC-2000 were added to the mixture, and the solution was separated. The resulting organic layer was concentrated. The resulting crude product was purified by silica gel column chromatography to obtain 18.5 g of a compound 6-3.

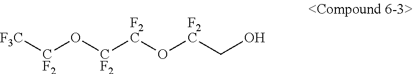 [SMILES: OCC(F)(F)OC(F)(F)C(F)(F)OC(F)(F)C(F)(F)F]

### Example 6-3

A compound A6 was obtained in the same manner as in Example 1-3 except that the compound 6-3 was used in place of the compound 1-2.

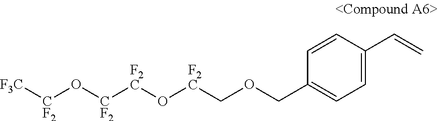 [SMILES: C=Cc1ccc(COCC(F)(F)OC(F)(F)C(F)(F)OC(F)(F)C(F)(F)F)cc1]

### Synthesis of Compound A7

### Example 7-1

A compound 7-1 was obtained in the same manner as in Example 6-1 except that CF₃CF₂CF₂—O—[CF(CF₃)CF₂—O]₂—CF(CF₃)COF was used in place of the compound 6-1.

### Compound 7-1

CF₃CF₂CF₂—O—[CF(CF₃)CF₂—O]₂—CF(CF₃)COOCH₃

### Example 7-2

A compound 7-2 was obtained in the same manner as in Example 6-2 except that the compound 7-1 was used in place of the compound 6-2.

### Compound 7-2

CF₃CF₂CF₂—O—[CF(CF₃)CF₂—O]₂—CF(CF₃)CH₂OH

### Example 7-3

A compound A7 was obtained in the same manner as in Example 1-3 except that the compound 7-2 was used in place of the compound 1-2.

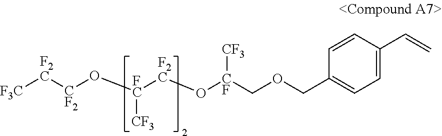

### Synthesis of Compound B11

### Example 11-1

To a 300 mL four-necked flask, 10 g of the compound 1-2 obtained in Example 1-2, 45 mL of AE-3000 (manufactured by AGC Inc.), 4 g of pyridine, 11 g of sodium hydrogen carbonate, and 9 g of ion-exchanged water were added, followed by stirring under ice cooling. Thereafter, 14 g of 3-chloropropionic acid chloride (manufactured by Tokyo Chemical Industry Co., Ltd.) was slowly added to the mixture. After the completion of the addition, the mixture was stirred for 30 minutes while being cooled, and then stirred at room temperature for 1 hour and 30 minutes. Thereafter, an aqueous potassium carbonate solution was added to the mixture, and the solution was separated. Then, the resulting organic layer was concentrated. The crude liquid obtained by concentration was added to a 300 mL four-necked flask. 104 g of triethylamine and 0.28 g of hydroquinone were sequentially added to the crude liquid, followed by stirring at 55° C. for 1.5 hours. Thereafter, the mixture was sequentially washed with 1 mol/L hydrochloric acid water, saline water, and sodium bicarbonate water. The resulting organic phase was concentrated and purified by silica gel column chromatography to obtain 8.9 g of a compound B11.

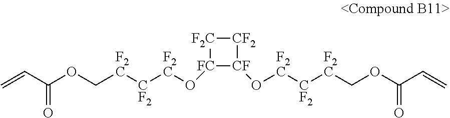

### Synthesis of Compound B12

### Example 12-1

A compound B12 was obtained in the same manner as in Example 11-1 except that FOMBLIN D2 (manufactured by Solvay Corporation) was used in place of the compound 1-2. The average value of the numbers of repetitions c1+d1 was 15, and d1/c1≈1 was set.

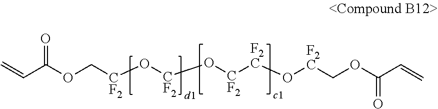

Details of the polymerization initiator, the compound B21, the compound B31, and the silane coupling agent used in Examples 1 to 17 are as follows.
Polymerization initiator . . . 2-hydroxy-2-methyl-1-phenylpropanone (product name “OMNIRAD 1173”, manufactured by IGM Resins B.V.)
Compound B21 . . . 1,6-hexanediol diacrylate (product name “B2936”, manufactured by Tokyo Chemical Industry Co., Ltd.)
Compound B31 . . . isobornyl acrylate (product name “I0638”, manufactured by Tokyo Chemical Industry Co., Ltd.)
Silane coupling agent . . . 3-acryloxypropyltrimethoxysilane (product name “KBM-5103”, manufactured by Shin-Etsu Chemical Co., Ltd.)

### Examples 1 to 17

Components shown in Tables 1 and 2 were mixed so as to have contents (% by mass) shown in Tables 1 and 2, to prepare curable compositions. In Table 1, “-” was described for components not contained.

The viscosity and curability of each of the curable compositions obtained in Examples 1 to 17 were evaluated. A cured film obtained by curing the curable composition obtained in each of Examples and Comparative Examples was evaluated for a dielectric constant and adhesion. The evaluation method is as follows.

### Viscosity

A dynamic viscoelasticity at a shear rate of 10 s⁻¹ was measured at 25° C. using a dynamic viscoelasticity measuring device (product name “PHYSICAMCR 301”, manufactured by Anton Paar GmbH). The evaluation criteria are as follows. A to C are at a level of no practical problem.

A: 25 mPa·s or less

B: more than 25 mPa·s and 40 mPa·s or less

C: more than 40 mPa·s and 50 mPa·s or less

D: more than 50 mPa·s

### Curability

The curable composition was applied onto a silicon substrate by spin coating, and irradiated with an ultraviolet ray at an exposure amount of 3000 mJ/cm² from a high-pressure mercury lamp under a nitrogen atmosphere. In a case in which the curable composition was not cured by irradiation with the ultraviolet ray, the curable composition was subjected to a heat treatment at 100° C. for 5 minutes after the irradiation with the ultraviolet ray. In a case in which the curable composition was not cured by the heat treatment for 5 minutes, the curable composition was subjected to a heat treatment at 100° C. for another 55 minutes. Whether or not the curable composition was cured was determined based on a peak derived from a polymerizable group in an infrared absorption spectrum obtained using an infrared spectrophotometer (product name: MAGNA 760, manufactured by Nikolet Company). In the measurement, an incident angle was fixed to 6.5 degrees, and a data interval was set to about 0.5 cm⁻¹. The curable composition was scanned 64 times, and the measured data were averaged. In a case in which the peak derived from the polymerizable group disappeared after the treatment, or in a case in which the height of the peak derived from the polymerizable group was reduced to 30% or less as compared with that before irradiation with the ultraviolet ray, the resin composition was determined to be cured. The evaluation criteria are as follows. A to C are at a level of no practical problem.

A: The curable composition was cured only by irradiation with an ultraviolet ray at an exposure amount of 3000 mJ/cm².

B: The curable composition was cured in a case in which the curable composition was irradiated with an ultraviolet ray at an exposure amount of 3000 mJ/cm², and then subjected to a heat treatment at 100° C. for 5 minutes.

C: The curable composition was cured in a case in which the curable composition was irradiated with an ultraviolet ray at an exposure amount of 3000 mJ/cm², and then subjected to a heat treatment at 100° C. for 60 minutes.

D: The curable composition was not cured even in a case in which the curable composition was irradiated with an ultraviolet ray at an exposure amount of 3000 mJ/cm², and then subjected to a heat treatment at 100° C. for 60 minutes.

### Dielectric Constant

The curable composition was applied onto a P-type silicon substrate by spin coating, irradiated with an ultraviolet ray at an exposure amount of 3000 mJ/cm² from a high-pressure mercury lamp under a nitrogen atmosphere, and then subjected to a heat treatment at 100° C. for 60 minutes to obtain a cured film having a thickness of 1.5 μm. The resulting cured film was subjected to capacitance-voltage (CV) measurement using a mercury prober (product name “SSM-495”, manufactured by SSM Inc.) to determine a relative permittivity at 100 kHz. The evaluation criteria are as follows. A to C are at a level of no practical problem.

A: 2.8 or less

B: more than 2.8 and 2.9 or less

C: more than 2.9 and 3.0 or less

D: more than 3.0

E: unmeasurable

### Adhesion

The curable composition was applied onto a SiN substrate by spin coating, irradiated with an ultraviolet ray at an exposure amount of 3000 mJ/cm² from a high-pressure mercury lamp under a nitrogen atmosphere, and then subjected to a heat treatment at 100° C. for 5 minutes to obtain a cured film having a thickness of 5 μm. The resulting cured film was subjected to the following crosscut-peeling test to evaluate the adhesion of the cured film to the SiN substrate.

First, 11 cuts were made in the surface of the cured film at intervals of 1 mm using a cutter knife. 11 cuts were made at intervals of 1 mm so as to be orthogonal to the cuts to form 100 squares. SELLOTAPE (registered trademark) was stuck to the squares, and the end of the SELLOTAPE was peeled off at once at an angle of 45°. The squares were visually observed, and the adhesion was evaluated based on the number of the squares not peeled off.

The evaluation criteria are as follows.

A: The number of the squares not peeled off is 80 or more.

B: The number of the squares not peeled off is less than 80.

TABLE 1

| | | Example | Example | Example | Example | Example | Example | Example | Example | Example | Example |
|---|---|---|---|---|---|---|---|---|---|---|---|
| | | 1 | 2 | 3 | 4 | 5 | 6 | 7 | 8 | 9 | 10 |
| Compound A | Type | A1 | A1 | A2 | A3 | A4 | A1 | A1 | A1 | A1 | A1 |
| | Content (% | 48 | 72 | 48 | 48 | 48 | 56 | 60 | 46 | 46 | 24 |
| | by mass) | | | | | | | | | | |
| | Molecular | 788 | 788 | 1800 | 4414 | 4342 | 788 | 788 | 788 | 788 | 788 |
| | weight | | | | | | | | | | |
| Compound B | Type | B11 | B11 | B11 | B11 | B11 | B31 | B21 | B11 | B11 | B11 |
| | Content (% | 48 | 24 | 48 | 48 | 48 | 40 | 36 | 30 | 30 | 72 |
| | by mass) | | | | | | | | | | |
| | Type | — | — | — | — | — | — | — | B21 | B21 | — |
| | Content (% | — | — | — | — | — | — | — | 10 | 10 | — |
| | by mass) | | | | | | | | | | |
| | Type | — | — | — | — | — | — | — | B31 | B31 | — |
| | Content (% | — | — | — | — | — | — | — | 10 | 5 | — |
| | by mass) | | | | | | | | | | |
| Polymerization | Content (% | 4 | 4 | 4 | 4 | 4 | 4 | 4 | 4 | 4 | 4 |
| initiator | by mass) | | | | | | | | | | |
| Silane coupling | Content (% | — | — | — | — | — | — | — | — | 5 | — |
| agent | by mass) | | | | | | | | | | |
| Evaluation | Viscosity | B | B | A | B | A | A | B | A | A | A |
| | Curability | B | B | B | B | B | B | A | A | A | B |
| | Dielectric | B | A | B | A | A | B | B | B | B | C |
| | constant | | | | | | | | | | |
| | Adhesion | — | — | — | — | — | — | — | B | A | — |

TABLE 2

| | | Example | Example | Example | Example | Example | Example | Example | Example |
|---|---|---|---|---|---|---|---|---|---|
| | | 11 | 12 | 13 | 14 | 15 | 16 | 17 | 18 |
| Compound A | Type | A5 | A6 | A1 | A1 | A7 | — | A2 | A1 |
| | Content (% by mass) | 48 | 72 | 92 | 72 | 48 | — | 96 | 50 |
| | Molecular weight | 5436 | 448 | 788 | 788 | 764 | — | 1800 | 788 |
| Compound B | Type | B11 | B11 | B21 | B12 | B11 | B11 | — | B11 |
| | Content (% by mass) | 48 | 24 | 4 | 24 | 48 | 99 | — | 50 |
| Polymerization | Content (% by mass) | 4 | 4 | 4 | 4 | 4 | 1 | 4 | — |
| initiator | | | | | | | | | |
| Evaluation | Viscosity | C | A | C | B | B | A | B | B |
| | Curability | C | B | C | C | B | A | D | D |
| | Dielectric constant | A | C | A | A | B | D | E | E |
| | Adhesion | — | — | — | — | — | — | — | — |

As shown in Table 1 and Table 2, in Example 1 to Example 15, the curable composition contained a compound A having a polymerizable group (a) and an oxyfluoroalkylene group, a polymerization initiator, and a compound B having a polymerizable group different from the polymerizable group (a). The polymerizable group (a) in the compound A was at least one selected from the group consisting of a vinylphenyl group, a vinylphenyloxy group, a vinylbenzyloxy group, a vinyloxy group, a vinyloxycarbonyl group, a vinylamino group, a vinylaminocarbonyl group, a vinylthio group, an allyloxy group, an allyloxycarbonyl group, an allylamino group, an allylaminocarbonyl group, an allylthio group, an epoxy group, and an epoxycycloalkyl group. The curable composition had a low viscosity, and the resulting cured film had a low dielectric constant.

In this regard, in Example 16, the compound A was not contained, whereby the dielectric constant of the resulting cured film was more than 3.0.

In Example 17, the compound B was not contained, whereby the curable composition had poor curability, and the dielectric constant of the cured film could not be measured.

In Example 18, the polymerization initiator was not contained, whereby the curable composition was not cured, and the dielectric constant of the cured film could not be measured.

In Example 1, it was found that the content of the compound A is 40% by mass to 90% by mass with respect to the total amount of the curable composition, whereby the dielectric constant of the resulting cured film is lower than that in Example 10 in which the content of the compound A is less than 40% by mass.

In Example 7, it was found that the content of the compound A is 40% by mass to 90% by mass with respect to the total amount of the curable composition, whereby the curable composition has a lower viscosity and more excellent curability than those in Example 13 in which the content of the compound A is more than 90% by mass.

In Example 2, it was found that the molecular weight of the compound A is 500 to 5000, whereby the resulting cured film has a dielectric constant lower than that in Example 12 in which the molecular weight of the compound A is less than 500.

In Example 3, it was found that the molecular weight of the compound A is 500 to 5000, whereby the curable composition has a viscosity lower than that in Example 11 in which the molecular weight of the compound A is more than 5000.

In Example 5, it was found that the compound A contains (OC₂F₄)_{c} and (OCF₂)_{d}, and d/c is 2 or more, whereby the curable composition has a viscosity lower than that in Example 4 in which d/c is less than 2.

It was found that Example 2 containing the compound B11 has more excellent curability than that in Example 14 containing the compound B12.

The content of the disclosure by Japanese Patent Application No. 2020-113383 filed on Jun. 30, 2020 is herein entirely incorporated by reference. All publications, patent applications, and technical standards mentioned in the specification are herein incorporated by reference to the same extent as if each individual publication, patent application, and technical standard were specifically and individually indicated to be incorporated by reference.

What is claimed is:

1. A curable composition comprising:
a compound A having a polymerizable group (a) and an oxyfluoroalkylene group;
a polymerization initiator; and
a compound B having a polymerizable group different from the polymerizable group (a),
wherein the polymerizable group (a) in the compound A is at least one selected from the group consisting of a vinylphenyl group, a vinylphenyloxy group, a vinylbenzyloxy group, a vinyloxy group, a vinyloxycarbonyl group, a vinylamino group, a vinylaminocarbonyl group, a vinylthio group, an allyloxy group, an allyloxycarbonyl group, an allylamino group, an allylaminocarbonyl group, an allylthio group, an epoxy group, and an epoxycycloalkyl group.

2. The curable composition according to claim 1, wherein a content of the compound A is 40% by mass to 90% by mass with respect to a total amount of the curable composition.

3. The curable composition according to claim 1, wherein a molecular weight of the compound A is 500 to 5000.

4. The curable composition according to claim 1, wherein the compound B is at least one selected from the group consisting of a compound B1 having a polymerizable group different from the polymerizable group (a) and having an oxyfluoroalkylene group, a compound B2 having two or more polymerizable groups and having no oxyfluoroalkylene group, and a compound B3 having one polymerizable group and having no oxyfluoroalkylene group.

5. The curable composition according to claim 1, wherein the polymerizable group in the compound B is at least one selected from the group consisting of a (meth)acryloyl group and a maleimide group.

6. The curable composition according to claim 1, wherein the compound A is a compound represented by the following Formula (1):
M¹ᵣ₁-Y¹-Rf¹-(OX)ₘ—O-Rf²-Y²-M²ᵣ₂ Formula (1)
wherein, in Formula (1):
each of M¹ and M² independently represents the polymerizable group (a);
each of r1 and r2 independently represents an integer of 1 or more;
Y¹ represents a (r1+1)-valent linking group having no fluorine atom;
Y² represents a (r2+1)-valent linking group having no fluorine atom;
Rf¹ represents a fluoroalkylene group in which a fluorine atom is bonded to a carbon atom bonded to Y¹;
Rf² represents a fluoroalkylene group in which a fluorine atom is bonded to a carbon atom bonded to Y²;
each X independently represents a fluoroalkylene group; and
m represents an integer of 1 or more.

7. The curable composition according to claim 6, wherein:
in Formula (1), (OX)ₘ includes a structure in which continuous (OX) is represented by the following Formula (2), and m represents an integer of 2 or more:
—(OX¹-OX²)ₐ— Formula (2)
wherein, in Formula (2):
X¹ represents a fluoroalkylene group having 1 to 6 carbon atoms;
X² represents a fluoroalkylene group having 1 to 6 carbon atoms and is different from X¹; and
a represents an integer of 1 or more, and satisfies 2≤(2×a)≤m.

8. The curable composition according to claim 6, wherein in Formula (1), (OX)ₘ includes (OC₄F₆)_{b}, and b is an integer of 1 or more.

9. The curable composition according to claim 6, wherein, in Formula (1):
(OX)ₘ includes (OC₂F₄)_{c} and (OCF₂)_{d};
each of c and d independently represents an integer of 1 or more; and
d/c is 0.8 or more.

10. The curable composition according to claim 6, wherein in Formula (1), (OX)ₘ includes (OC₃F₆)ₑ, and e is an integer of 1 or more.

11. The curable composition according to claim 6, wherein in Formula (1), each of Y¹ and Y² independently represents a single bond or represents a linking group containing at least one selected from the group consisting of an alkylene group, an arylene group, —C(═O)—, —O—, —S—, —NH—, —N<, —SiH₂—, >SiH—, and >Si<.

12. The curable composition according to claim 1, wherein a content of an organic solvent is 1% by mass or less with respect to a total amount of the curable composition.

13. The curable composition according to claim 1, further comprising a silane coupling agent.

14. A cured film, which is a cured product of the curable composition according to claim 1.

15. A method of producing a cured film, the method comprising:
applying the curable composition according to claim 1 onto a substrate; and
irradiating the curable composition with an active energy ray.

16. An element comprising the cured film according to claim 14.

17. The element according to claim 16, wherein the element is used for a sensor.

18. The element according to claim 16, wherein the element is used for optics.

19. A display device comprising an optical element, which is the element according to claim 18.
